(19) United States
(12) Patent Application Publication
(10) Pub. No.: US 2006/0247007 A1
(43) Pub. Date: Nov. 2, 2006

(54) Gaming system, gaming terminal and server utilized therein

(75) Inventor: Yukinori Inamura, Tokyo (JP)

Correspondence Address: LEYDIG VOIT & MAYER, LTD, 700 THIRTEENTH ST. NW, SUITE 300, WASHINGTON, DC, 20005-3960, US

(73) Assignee: ARUZE corp., Tokyo (JP)

(21) Appl. No.: 11/405,446

(22) Filed: Apr. 18, 2006

(30) Foreign Application Priority Data
Apr. 19, 2005 (JP) 2005-121142

(51) Int. Cl. A63F 13/00

(52) U.S. Cl. 463/20

(57) ABSTRACT

A gaming system, a gaming terminal and a server being utilized in the gaming system are provided to enhance the player's desire to play the game and the player's anticipation to the progressive function, image display contents or outputted sound contents are changed according to a predetermined game level being selected from a plurality of game levels relating to the progressive function of each gaming terminal based on a lottery result by the server. Game processes (S21-S33) utilizing effects corresponding to the currently set game level are conducted with each of the slot machines 101A to 101E, and the server 102 performs a lottery to determine whether to change the game level being set as the starting operation of the game is conducted in each of the slot machines 101A to 101E.

### CROSS REFERENCE TO RELATED APPLICATIONS

This application is based upon and claims the benefits of priorities from Japanese Patent Application No. 2005-121142 filed on Apr. 19, 2005, the entire contents of which are incorporated herein by reference. This application is also related to a co-pending U.S. patent application entitled “Gaming System, Gaming Terminal, Server and Display Device Utilized Therein” and being filed on even date herewith and being assigned to the same assignee as the present application. The co-pending application including specification, drawings and claims are expressly incorporated herein by reference in its entirety.

### FIELD OF THE INVENTION

The present invention relates to a gaming system, gaming terminals and a server utilized in the gaming system, being provided with a so-called progressive function to pay out a cumulatively stored game media under a predetermined condition wherein the gaming system comprises: a plurality of gaming terminals and a server, wherein a plurality of game levels are set based on a lottery result by the server, and wherein image display contents and sound output vary depending on the game level set on the gaming terminal such that a player may have more anticipation to the progressive function and that a variety of game contents, which entertain the player well, may be provided.

### RELATED ART

Conventionally, in a gaming system comprising a plurality of gaming terminals and a server being connected with each other in a communicable way, by way of example, there are a slot machine and a bingo game machine, which are typically installed in a casino and an arcade. In the gaming machine as a gaming terminal provided to the gaming system, medal or coins are inserted to start the game and a predetermined number of medals or coins are paid out to the player depending on the game results. If the above gaming system is applied to such a gaming machine, the game with a so-called progressive function may be played such that a part (e.g., 1%) of the medals or coins bet by the player at each gaming machine is cumulatively added to the jackpot and that the accumulated amount is once paid out to the player playing the game with a particular gaming machine which satisfies a predetermined payout condition (e.g., a condition that the internal lottery is won, a condition that the amount of gaming media so far inserted into the gaming machine reaches a predetermined amount, etc.). For example, Japanese Unexamined Patent Publication Number 2004-130119 discloses a gaming system where the jackpot is to be paid out if a predetermined condition is satisfied in a special game, which is played only for winning the jackpot in a plurality of gaming terminals only when a jackpot management device determines that the jackpot can be paid out.

However, in the gaming system disclosed by Japanese Unexamined Patent Publication Number 2004-130119, it is determined whether the jackpot is won or not by the lottery process in the jackpot management device or gaming terminals as the game is started although the special game to win the jackpot is conducted such that a variety of game having the progressive function can be provided.

Here, the lottery to win the jackpot is conducted at each gaming terminal independently from each other, and the probability to win the jackpot is basically the same at any gaming terminal and the probability does not change. Therefore, if the game is shifted to the special game in such conventional gaming system, the player would have more anticipation to win the jackpot, but the gaming state at each gaming terminal is not changed based on the information about the progressive function unless the game shifts to the special game so that only the base game is played. Thus, the player may lose the anticipation to win the jackpot and his desire to play the game may be lowered.

### SUMMARY OF THE INVENTION

In the present invention, a gaming system comprises: a plurality of gaming terminals, each of which accepts game media, accepts a player's operation, conducts a predetermined notification, and pays out a predetermined value of the game media based on operation information of the player's operation and a game result caused by the operation information; and a server being connected to the plurality of gaming terminals and including a memory for storing cumulatively a predetermined portion of total game media accepted by the plurality of gaming terminals. Each of the gaming terminals controls the predetermined notification based on a game state in the each of the gaming terminals and game level instruction information sent from the server and pays out a cumulatively stored value amount stored in the memory based on payout instruction information sent from the server. The server sets one game level out of a plurality of game levels to each of the plurality of gaming terminals, conducts a lottery to determine whether to change the game level having been set to each of the plurality of gaming terminals so as to send game level instruction information to instruct each of the plurality of gaming terminals based on the lottery result, determines that game levels of which gaming terminals are changed to predetermined game levels, and instructs one of the plurality of gaming terminals to pay out the cumulatively stored value amount stored in the memory when it is determined that the game level of the one of the plurality of gaming terminals is changed.

Further features of the present invention, its nature, and various advantages will be more apparent from the accompanying drawings and the following description of the preferred embodiment.

### BRIEF DESCRIPTION OF THE DRAWINGS

FIG. 1 is a schematic drawing illustrating a general configuration of the gaming system according to a first embodiment.

FIG. 2 is a perspective view illustrating an outer appearance of a slot machine according to the first embodiment.

FIG. 3 is a front view showing variable display parts of the slot machine according to the first embodiment.

FIG. 4 is a front view showing an operation table of the slot machine according to the first embodiment.

FIGS. 5A to 5E are schematic diagrams of a first reel band to a fifth reel band of symbol arrays being variably displayed in the variable display parts

FIG. 6 is a schematic block diagram illustrating a control system of the slot machine of the gaming system according to the first embodiment.

FIG. 7 is a schematic block diagram illustrating a control system of the server of the gaming machine according to the first embodiment.

FIG. 8 is a diagram showing each storage area in ROM of the slot machine according to the first embodiment.

FIG. 9 is a diagram showing each storage area in RAM of the slot machine according to the first embodiment.

FIG. 10 is a diagram showing each storage area in ROM of the server according to the first embodiment.

FIG. 11 is a diagram showing each storage area in RAM of the server according to the first embodiment.

FIG. 12 illustrates an advance notification effect selection table according to the first embodiment.

FIG. 13 illustrates a background color selection table according to the first embodiment.

FIGS. 14A to 14C illustrate game level lottery tables according to the first embodiment.

FIG. 15 illustrates a display screen on an external liquid crystal display according to the first embodiment.

FIG. 16 is a flow chart of a game processing program of the gaming system according to the first embodiment.

FIG. 17 is a flow chart of an advance notification effect processing program of the slot machine according to the first embodiment.

FIG. 18 is a flow chart of a game level lottery processing program of the slot machine according to the first embodiment.

FIG. 19 is a front view showing an image displayed on the lower crystal display as the advance notification of the bonus game in a condition that the game level is set as “Level 0.”

FIG. 20 is a front view showing an image displayed on the lower crystal display as the advance notification of the bonus game in a condition that the game level is set as “Level 1.”

FIG. 21 is a front view showing an image displayed on the lower crystal display as the advance notification of the bonus game in a condition that the game level is set as “Level 2.”

FIG. 22 is a front view showing an image displayed on the lower crystal display as the JP is won.

FIG. 23 is a flow chart of a game processing program of the gaming system according to the second embodiment.

FIG. 24 is a flow chart of a game processing program of the gaming system according to another embodiment.

### DESCRIPTION OF THE PREFERRED EMBODIMENT

Hereinafter, in a gaming system according to the present invention, a detailed explanation will be made for a first embodiment and a second embodiment comprising a server and a plurality of slot machines, which may be referred to as gaming terminals, in reference to the drawings.

### First Embodiment

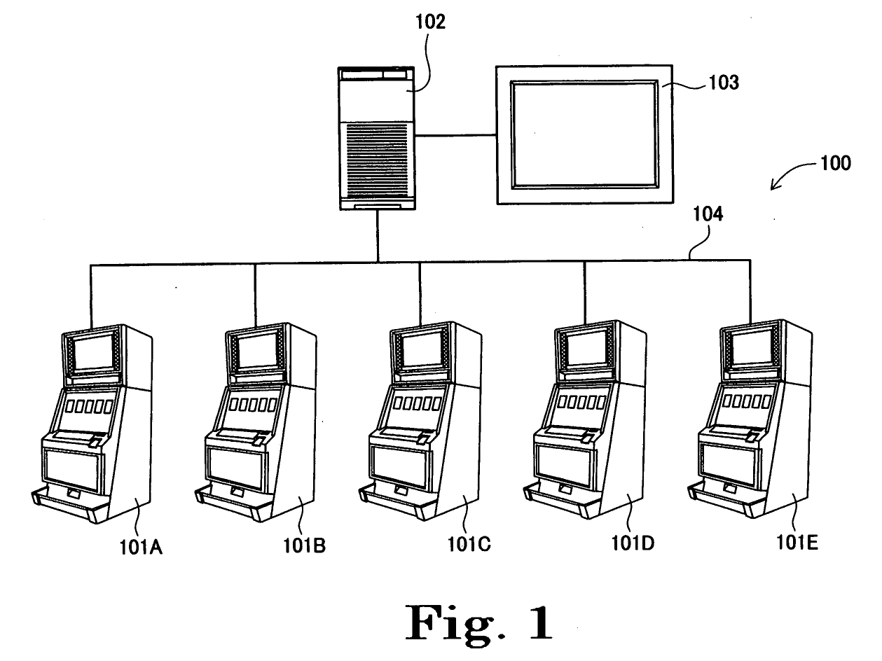

First, an explanation will be made for a general configuration of a gaming system 100 according to the first embodiment in reference to the drawings. FIG. 1 is a view showing a general configuration illustrating the gaming system 100 according to the first embodiment.

The gaming system 100 is composed of a plurality of slot machines 101A, 101B, 101C, 101D and 101E with which a game may be played by inserting medals (five units of the slot machines in the first embodiment), one unit of a server 102 for managing the slot machines 101A, 101B, 101C, 101D and 101E individually, and an external liquid crystal display 103 to notify players of various information about an amount of a jackpot (hereinafter, referred to as “JP”).

Then, the slot machines 101A, 101B, 101C, 101D, 101E and the server 102 are connected by wired and/or wireless communications lines 104 so that necessary data can be mutually communicated, as will be described later.

The slot machines 101A, 101B, 101C, 101D, 101E are characterized in that a video reel is used and a predetermined amount of credits and the like are paid out when varying symbols are stopped on an activated winning line to form a predetermined combination. Further, in the slot machines 101A, 101B, 101C, 101D, 101E of the first embodiment, each game level related to the winning probability at which the jackpot is awarded is set to any one of “level 0” to “level 3,” and contents displayed on a lower liquid crystal display 4 and sounds outputted from speakers 5L and 5R are changed, as will be described later, on the basis of the thus set game level. In addition, the number of credits received (or bet) at the time of starting the game is sent to the server 102 via the communications lines 104, and when the game is over, the game results (the number of credits paid out in the current game) are also sent to the server 102. The game level will be described later in detail.

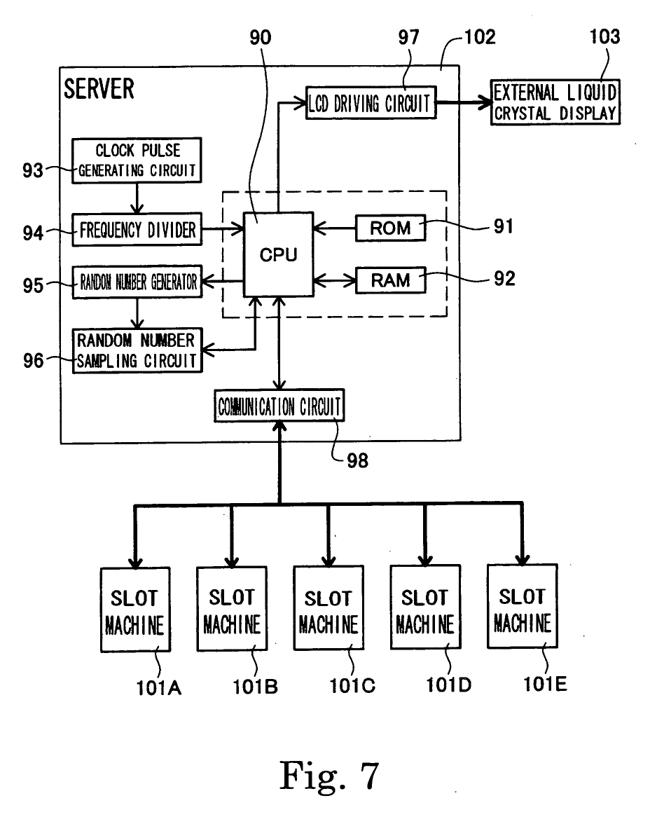

The server 102 is provided with cumulative storing means (e.g., RAM 92 in FIG. 7) for cumulatively storing a predetermined percentage of credits as JP (1% in the first embodiment) having been received (or bet) in each of the slot machines 101A, 101B, 101C, 101D, 101E and game level lottery-means (e.g., CPU 90 in FIG. 7) for performing a lottery to determine whether to change the current game level of each of the slot machines 101A, 101B, 101C, 101D, 101E when the game is started in the slot machines 101A, 101B, 101C, 101D, 101E such that the lottery results are sent to the respective slot machines 101A, 101B, 101C, 101D, 101E via the communications lines 104.

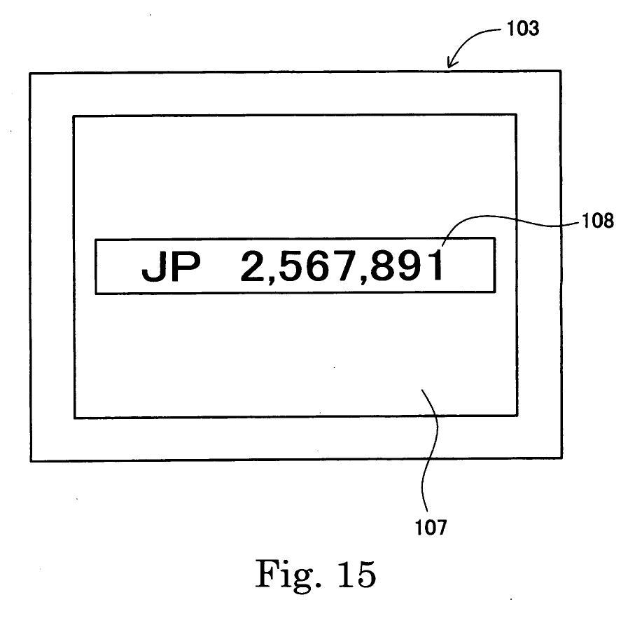

Further, the external liquid crystal display 103 is installed on an upper part of a wall over the slot machines 101A, 101B, 101C, 101D, 101E, and a display screen thereof can be visually recognized by all players who play the game in the respective slot machines 101A, 101B, 101C, 101D, 101E and people around the slot machines 101A, 101B, 101C, 101D, 101E. Then, the amount of JP accumulated so far in the server 102 are displayed on the external liquid crystal display 103, as described in detail later (refer to FIG. 15).

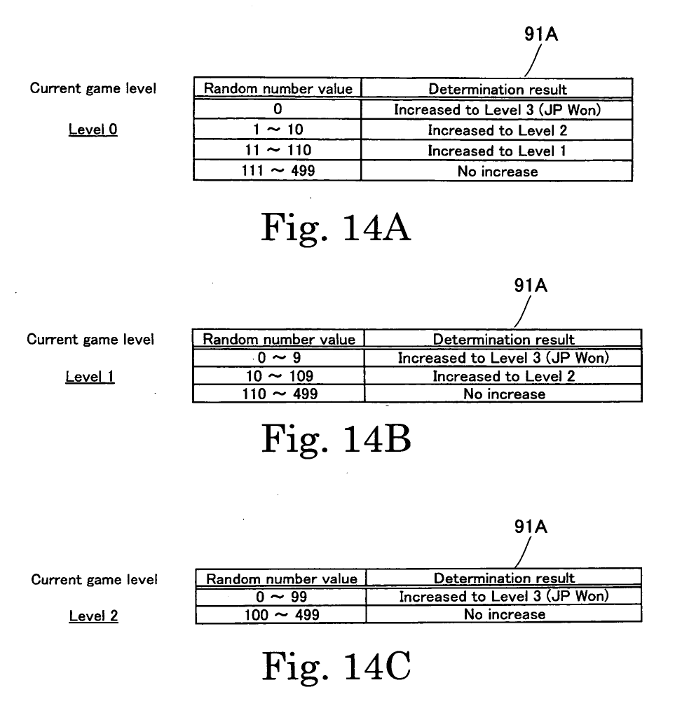

Now, an explanation will be made for the game level. The game level comprises four levels, namely, “level 0,” “level 1,” “level 2” and “level 3.” Any one of these game levels is set in each of the slot machines 101A, 101B, 101C, 101D, 101E. Then, when the game is started in each of the slot machines 101A, 101B, 101C, 101D, 101E, the server 102 determines by the lottery whether the current game level in each corresponding slot machine is to be increased or not. When it is determined that the game level should be increased, the game level set currently is increased to a predetermined level (there rare six patterns in increasing the game level on the basis of the lottery result by the server 102: from “level 0” to “level 1,” from “level 1” to “level 2,” from “level 2” to “level 3,” from “level 0” to “level 2,” from “level 1” to “level 3,” from “level 0” to “level 3” (refer to FIG. 14)). The slot machines are so configured that the amount of JP stored in the server 102 is paid out when one of the game levels reaches the highest level, or “level 3” (i.e., the JP is won). In this instance, the probability at which the game level is increased to “level 3,” namely, the probability at which the JP is won, varies according to each current game level. More specifically, the probability is set higher in the current game level of “level 1” than “level 0,” and it is set higher in the current game level of “level 2” than “level 1” (refer to FIG. 14). Therefore, the game level set currently in the slot machines 101A, 101B, 101C, 101D, 101E indicates the probability or likeliness to win the JP.

The server 102 may be installed inside one of the plurality of slot machines 101A, 101B, 101C, 101D, 101E. Further, the gaming system 100 may be used in such a way that the plurality of slot machines installed all together at one place such as a game arcade are connected to the server 102 or a larger number of slot machines installed separately over a wide area are connected to the server 102.

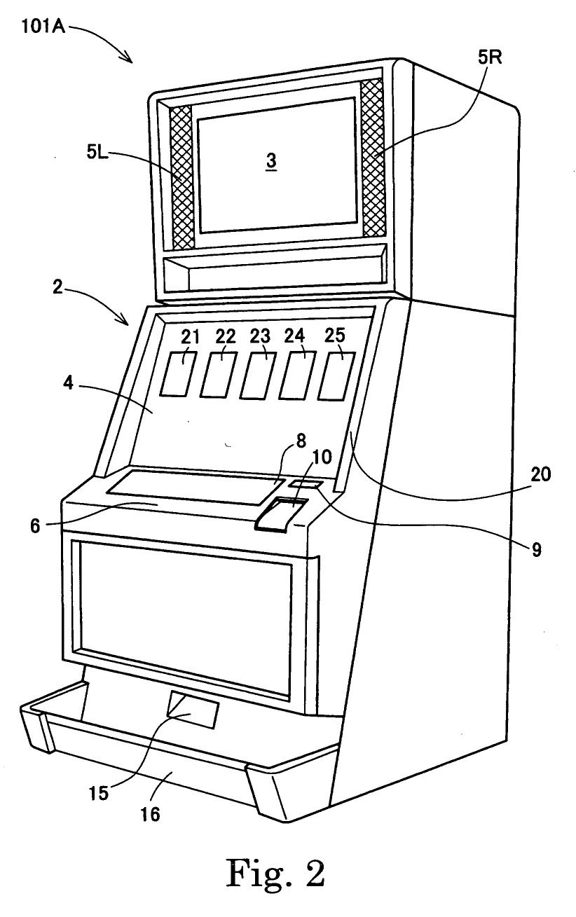

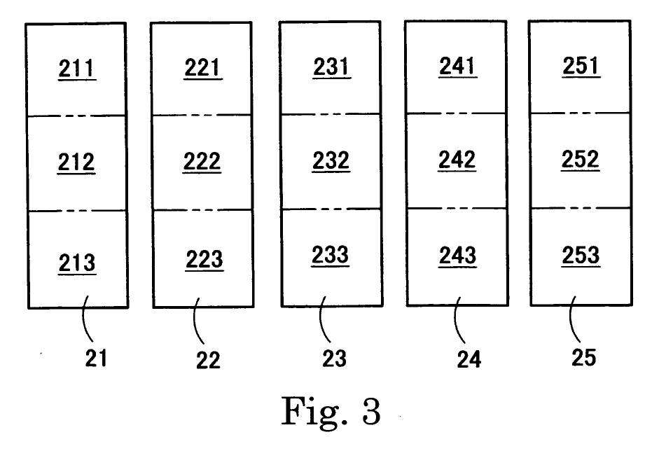

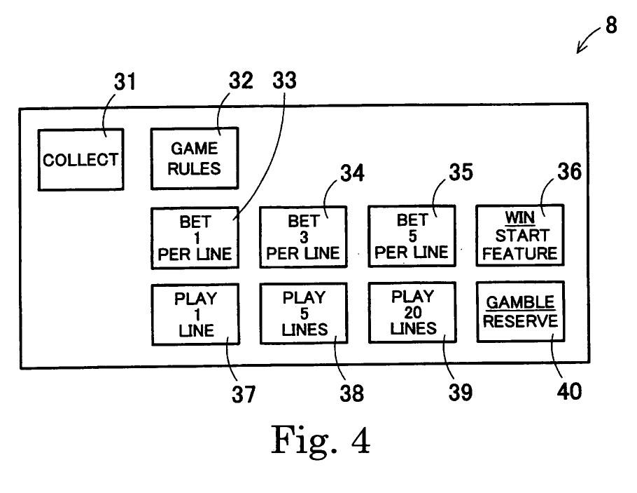

Next, an explanation will be made for a general configuration of the slot machines 101A, 101B, 101C, 101D, 101E, constituting the gaming system 100, by picking up the slot machine 101A as an example, with reference to FIGS. 2 through 4. Further, the other slot machines 101B to 101E are basically the same in the configuration as the slot machine 101A, such that the explanation thereof is omitted here. FIG. 2 is a perspective view illustrating an outer appearance of the slot machine 101A of the first embodiment. FIG. 3 is a front elevational view illustrating variable display parts 21 through 25 of the slot machine 101A of the first embodiment. FIG. 4 is a front elevational view illustrating an operation panel 8 of the slot machine 101A of the first embodiment.

As illustrated in FIG. 2, the slot machine 101A is provided with a cabinet 2 forming the whole outer appearance thereof. An upper liquid crystal display 3 is disposed at the front upper part of the cabinet 2, and a lower liquid crystal display 4 is disposed on a front panel 20 provided at the center of the front surface of the cabinet 2. The upper liquid crystal display 3 and the lower liquid crystal display 4 are composed of commercially available liquid crystal displays.

Further, a pair of speakers 5L and 5R are provided on both sides of the upper liquid crystal display 3, reproducing a predetermined BGM (back-ground music), voices, effect sounds and the like to the player on the basis of the game mode of the slot machine 101A. In addition, an operation table 6 which is projected forward is provided below the lower liquid crystal display 4. The operation table 6 is provided with an operation panel 8 in which various buttons are arranged from the left to the right, a coin insertion part 9 for insertion of game media such as coins, and a bill insertion part 10 for insertion of bills.

The upper liquid crystal display 3 displays the information about the game such as a way to play the game, kinds of winning combinations and payout rates thereof, various effects for the game and the like. Further, the lower liquid crystal display 4 displays the number of credits that the player currently has and various effect images, and is provided with five variable display parts, 21, 22, 23, 24 and 25 in the middle of a display screen thereof. Then, various types of symbols to be described later are variably displayed on these variable display parts 21 through 25, as the various types of symbols are scrolling from the top to the bottom, and a combination of predetermined symbols are stopped and displayed in the windows after a certain period of time elapses.

Therefore, the slot machine 101A of the first embodiment is a so called video slot machine in which a video reel realized by showing symbols via each of variable display parts 21 through 25 of the lower liquid crystal display 4 is used to conduct the slot game (being composed of two types of games, namely, a base game and a bonus game). In the slot game of the first embodiment (base game and bonus game), three symbols are stopped and displayed at each of the variable display parts 21 through 25 (a total of 15 symbols).

More specifically, as illustrated in FIG. 3, the variable display parts 21 through 25 are respectively separated to the first stop display areas, 211, 221, 231, 241 and 251, the second stop display area, 212, 222, 232, 242 and 252, and the third stop display area, 213, 223, 233, 243 and 253, and predetermined symbols are stopped and displayed on individual stop display areas, namely, 211 through 213, 221 through 223, 231 through 233, 241 through 243 and 251 through 253 on the basis of results of the internal lottery, which will be described later.

Further, in the slot game (a base game and a bonus game), there are 20 winning lines which are formed with five areas, among the stop display areas of 211 through 213, 221 through 223, 231 through 233, 241 through 243 and 251 through 253. In each of the winning lines, if activated, a payout is given when particular symbols are stopped and displayed in the individual areas so as to be arranged in a particular mode. Then, an explanation will be made for each of the winning lines.

A first winning line L1 is formed with the second stop display areas 212, 222, 232, 242 and 252. A second winning line L2 is formed with the first stop display areas 211, 221, 231, 241 and 251. A third winning line L3 is formed with the third stop display areas 213, 223, 233, 243 and 253. In a similar way, a fourth winning line L4 through a 20th winning line L20 are individually formed with the stop display areas 211 through 213, 221 through 223, 231 through 233, 241 through 243 and 251 through 253.

Further, in this instance, among twenty of the above-described activated lines, an activated winning line being activated by the operation of each BET button as described later (BET 1 PER LINE button 33, BET 3 PER LINE button 34 and BET 5 PER LINE button 35) may be referred to as “activated winning line.”

In addition, various operation buttons are arranged on an operation panel 8 provided on the operation table 6. A specific explanation will be made for individual operation buttons in referring to FIG. 4. A COLLECT button 31 and a GAME RULES button 32 are arranged at the upper part of the operation panel 8 in sequence from the leftmost side. A BET 1 PER LINE button 33, a BET 3 PER LINE button 34, a BET 5 PER LINE button 35 and a WIN START FEATURE button 36 are arranged at the middle part thereof in sequence from the leftmost side. A PLAY 1 LINE button 37, a PLAY 5 LINES button 38, a PLAY 20 LINES button 39 and a GAMBLE RESERVE button 40 are disposed at the lower part thereof in sequence from the leftmost side.

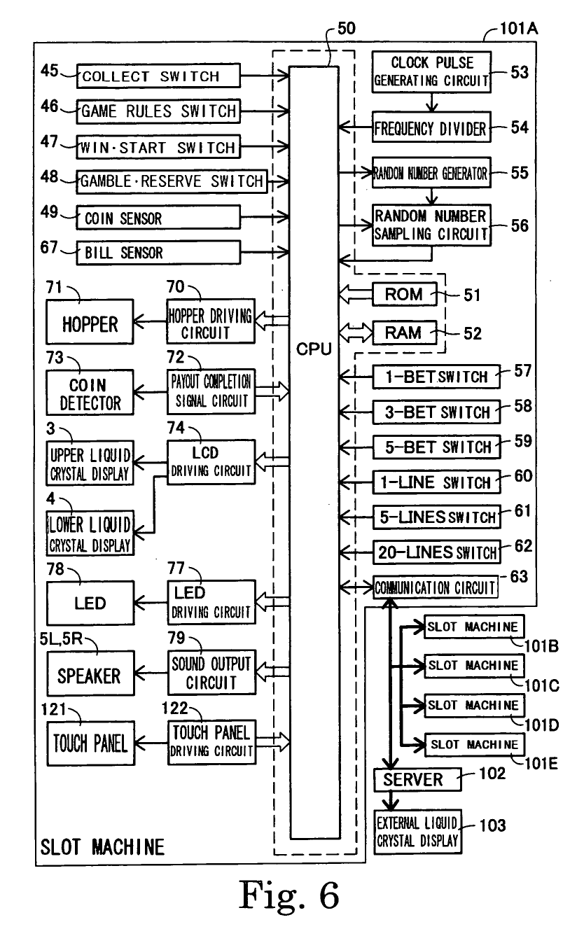

In this instance, the COLLECT button 31 is a button usually depressed at completion of the game. When the COLLECT button 31 is depressed, coins equivalent in value to the number of credits obtained in the game concerned are paid out to a coin receiving part 16 from a coin payout slot 15 to be described later via a hopper (not illustrated) installed inside the slot machine 101A. A COLLECT switch 45 is annexed to the COLLECT button 31, and switch signals are outputted to a CPU 50 by depressing the COLLECT button 31 (refer to FIG. 6).

The GAME RULES button 32 is a button depressed when an operation method of the game and the like are not known. When the GAME RULES button 32 is depressed, various types of help information are displayed on an upper liquid crystal display 3 and a lower liquid crystal display 4. A GAME RULES switch 46 is annexed to the GAME RULES button 32, and switch signals are outputted from the GAME RULES switch 46 to the CPU 50 upon depression of the GAME RULES button 32 (refer to FIG. 6).

The BET 1 PER LINE button 33 is a button to bet one credit of the credits currently owned by the player with respect to each of activated winning lines for every depression. A 1-BET switch 57 is annexed to the BET 1 PER LINE button 33, and a switch signal is outputted from the 1-BET switch 57 to the CPU 50 upon depression of the BET 1 PER LINE button 33 (refer to FIG. 6).

The BET 3 PER LINE button 34 is a button to start the game with three bets (credits) for each of the activated winning lines by the depression thereof. A 3-BET switch 58 is annexed to the BET 3 PER LINE button 34, and a switch signal is outputted from the 3-BET switch 58 to the CPU 50 upon depression (refer to FIG. 6).

Further, the BET 5 PER LINE button 35 is a button to start the game with five bets (credits) for each of the activated winning lines on depression. A 5-BET switch 59 is annexed to the BET 5 PER LINE button 35, and a switch signal is outputted from the 5-BET switch 59 to the CPU 50 on depression (refer to FIG. 6).

Therefore, the number of bets to be bet for each line of the activated winning lines is determined by depressing the BET 1 PER LINE button 33, the BET 3 PER LINE button 34 or the BET 5 PER LINE button 35.

Further, the WIN START FEATURE button 36 is a button for starting a bonus game to be explained later or adding payouts obtained in the bonus game to credits. A WIN/START switch 47 is annexed to the WIN START FEATURE button 36 and a switch signal is output from the WIN/START switch 47 to the CPU 50 on depression (refer to FIG. 6).

The PLAY 1 LINE button 37 is a button for starting the game, with the number of the activated winning lines given as “1,” on depression. A 1-LINE switch 60 is annexed to the PLAY 1 LINE button 37, and a switch signal is outputted from the 1-LINE switch 60 to the CPU 50 on depression (refer to FIG. 6).

The PLAY 5 LINES button 38 is a button for starting a game, with the number of activated winning lines given as “5,” on depression. A 5-LINES switch 61 is annexed to the PLAY 5 LINES button 38, and a switch signal is outputted from the 5-LINES switch 61 to the CPU 50 on depression (refer to FIG. 6).

The PLAY 20 LINES button 39 is a button for starting the game, with the number of activated winning lines given as “20,” on depression. A 20-LINES switch 62 is annexed to the PLAY 20 LINES button 39, and a switch signal is outputted from the 20-LINES switch 62 to the CPU 50 on depression (refer to FIG. 6).

Therefore, the number of activated winning lines is determined by depressing the PLAY 1 LINE button 37, the PLAY 5 LINES button 38 or the PLAY 20 LINES button 39.

In this instance, when the PLAY 1 LINE button 37 is depressed, the above-described first winning line L1 is activated. Further, when the PLAY 5 LINES button 38 is depressed, the first winning line L1 through the fifth winning line L5 are activated. Further, when the PLAY 20 LINES button 39 is depressed, the first winning line L1 through 20th winning line L20 are all activated.

The PLAY 1 LINE button 37, the PLAY 5 LINES button 38 and the PLAY 20 LINES button 39 also act as a start button by which individual symbols are varied and displayed at variable display parts 21 through 25 on a lower liquid crystal display 4 in order to start the game by referring to the number of present bets and the number of the activated winning lines concerned, once these buttons are depressed.

The GAMBLE RESERVE button 40 is a button which is depressed when the player leaves his or her seat or which is depressed to shift the game to a double down game after completion of the bonus game. In this instance, the double down game is a game which is conducted by using credits obtained in the bonus game, details of which are omitted here.

A GAMBLE•RESERVE switch 48 is annexed to the GAMBLE RESERVE button 40, and a switch signal is outputted from the GAMBLE-RESERVE switch 48 to the CPU 50 when the switch is depressed (refer to FIG. 6).

A coin sensor 49 is arranged at a coin insertion part 9. When coins are inserted into the coin insertion part 9, a coin detection signal is outputted to the CPU 50 via the coin sensor 49 (refer to FIG. 6), thereby adding credits equivalent in value to the thus inserted coins. Further, a bill sensor 67 is arranged at a bill insertion part 10. When bills are inserted into the bill insertion part 10, a bill detection signal is outputted to the CPU 50 via the bill sensor 67 (refer to FIG. 6), thereby adding credits equivalent in value to the thus inserted bills.

A cabinet 2 is provided at the lower part with a coin payout slot 15 and also with a coin receiving part 16 for receiving coins paid out from the coin payout slot 15. A hopper 71 capable of discharging coins one by one and a coin detecting part 73 being composed of sensors and the like and described later are arranged inside the coin payout slot 15 (refer to FIG. 6) and the coin detecting part 73 detects the number of coins paid out from the coin payout slot 15. Further, in place of directly paying out coins, the cabinet may be so configured as to issue a receipt-like substance (a piece of paper) which describes the number of coins (value). In this instance, the player is able to bring the issued substance (e.g., ticket) to a counter of a game shop, thereby obtaining prizes and the like with the substance (ticket).

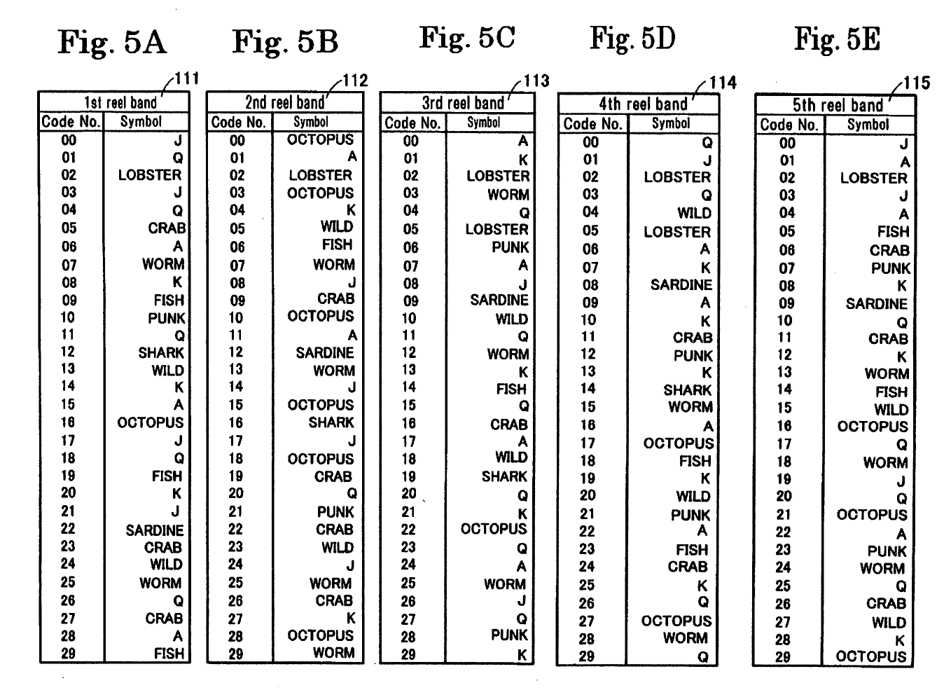

Then, an explanation will be made in referring to FIG. 5 for symbol examples varied and displayed at variable display parts 21 through 25 on the lower liquid crystal display 4, as they are scrolled in a base game and a bonus game. In FIG. 5, the array of symbols indicated at the first reel band 111 is an array of symbols varied and displayed at the variable display part 21, the array of symbols indicated at the second reel band 112 is an array of symbols varied and displayed at the variable display part 22, the array of symbols indicated at the third reel band 113 is an array of symbols varied and displayed at the variable display part 23, the array of symbols indicated at the fourth reel band 114 is an array of symbols varied and displayed at the variable display part 24, and the array of symbols indicated at the fifth reel band 115 is an array of symbols varied and displayed at the variable display part 25.

Dot data for forming images for the arrays of symbols indicated at the first reel band 111 through the fifth reel band 115 are accommodated in an image ROM inside a liquid-crystal driving circuit 74.

Here, the arrays of symbols indicated at the first reel band 111 through the fifth reel band 115 are provided with respectively different symbol arrangements, but each of these arrays of symbols is composed of thirteen kinds of symbols such as “LOBSTER,” “SHARK,” “FISH,” “PUNK,” “OCTOPUS,” “CRAB,” “WORM,” “A,” “K,” “Q,” “J,” “WILD” and “SARDINE” as they are combined appropriately.

In this instance, “LOBSTER” is a symbol which depicts a lobster. “SHARK,” “FISH,” “PUNK,” “OCTOPUS,” “CRAB,” “WORM” and “SARDINE” are symbols which respectively depict shark, fish, man with a guitar, octopus, crab, worm and sardine. Further, “A,” “K,” “Q,” “J” and “WILD” are symbols of alphabetic letters.

Then, where “LOBSTER,” “SHARK,” “FISH,” “PUNK,” “OCTOPUS,” “CRAB,” “WORM,” “A,” “K,” “Q” and “J” are stopped and displayed in a predetermined number from the leftmost side along the first to the 20th winning lines L1 through L20, a predetermined number of credits are added as credits owned by the player.

Further, “SARDINE” is a so called a scatter symbol, and when two or more of “SARDINE” are stopped and displayed at the same time from the variable display parts 21 through 25, a predetermined number of credits are added as credits owned by the player, irrespective of an activated winning line. In addition, as will be explained later, “SARDINE” is a shift symbol to the bonus game so as to shift the game mode to the bonus game mode, and when four or more of such symbols are stopped and displayed at the same time from the variable display parts 21 through 25, the game can be shifted to the bonus game, irrespective of the activated winning lines. The bonus game played in each slot machine 101A, 101B, 101C, 101D, 101E of the first embodiment is a so-called free game, and the bonus game is allowed to be played for a predetermined number of times (for example, 15 times), without consumption of the credits.

In addition, “WILD” is a so-called wild symbol which is used in place of any one of symbols other than “SARDINE” (scatter symbol).

When any of the PLAY 1 LINE button 37, the PLAY 5 LINES button 38 or the PLAY 20 LINES button 39 is depressed to start the game, arrays of symbols indicated at the first reel band 111 through the fifth reel band 115 are scrolled and displayed from the top to the bottom at each of the variable display parts 21 through 25 and three symbols are stopped and displayed at each of these variable display parts after a predetermined period of time elapses.

Further, among the plurality of combinations of the above-described symbols, some winning combinations are already set before the game. When a combination of symbols corresponding to one of the winning combinations is stopped on an activated winning line, a payout corresponding to the winning combination is credited. Where four or more “SARDINE” symbols are stopped and displayed at the same time, irrespective of the winning line, the game mode is shifted to the bonus game mode.

Next, an explanation will be made for a configuration related to a control system of the gaming system 100 in referring to FIGS. 6 and 7. FIG. 6 is a block diagram graphically illustrating the control system of the slot machine 101A of the gaming system 100. FIG. 7 is a block diagram graphically illustrating the control system of the server 102 of the gaming system 100.

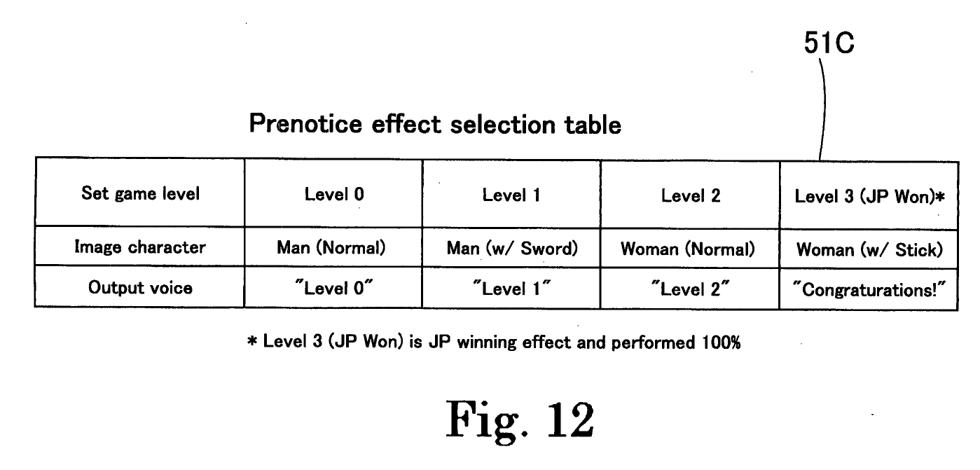

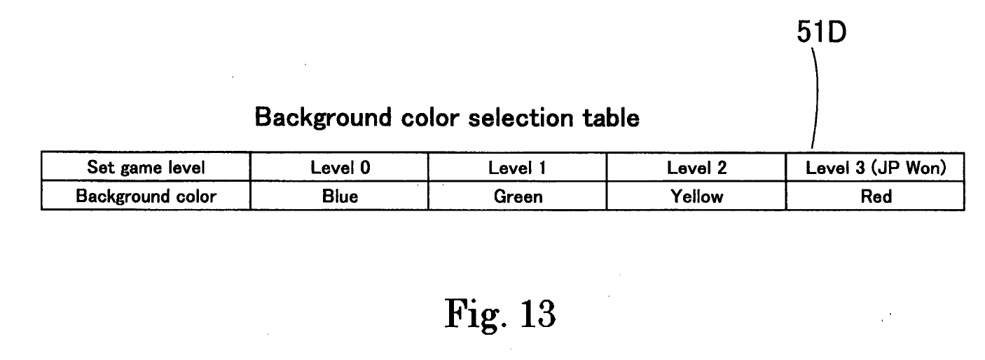

As illustrated in FIG. 6, the control system of the slot machine 101A, which constitutes the gaming system 100, is basically composed of a CPU 50 as a core component, and the CPU 50 is connected with a ROM 51 and a RAM 52. The ROM 51 stores a main processing program to be explained later, a base game processing program, a bonus game processing program, a symbol lottery table for selecting symbols stopped and displayed, winning combinations which may appear as a combination of stopped and displayed symbols, a payout table for setting credits paid out based on the winning combination, an advance notification effect selection table for selecting an advance notification effect provided at the time of changing symbols in the slot machine 101A based on the game level set currently (refer to FIG. 12), a background color selection table for selecting a background color on the lower liquid crystal display 4 of the slot machine 101A on the basis of the game level set currently (refer to FIG. 13), audio data of individual characters outputted from speakers at the time of providing effects, and other various programs and data tables necessary for controlling the slot machine 101A. Further, the RAM 52 is a memory for temporarily storing the number of credits owned currently by the player, the game level set currently in the slot machine 101A (any one of “level 0,” “level 1,” “level 2” or “level 3”) and various data calculated by the CPU 50.

The CPU 50 is connected with a clock pulse generating circuit 53 for generating a reference clock pulse and a frequency divider 54, and also connected with a random number generator 55 for generating random numbers and a random number sampling circuit 56. Random numbers sampled via the random number sampling circuit 56 are used for various lotteries such as winning combinations. Further, the CPU 50 is connected with a COLLECT switch 45 annexed to a COLLECT button 31, a GAME RULES switch 46 annexed to a GAME RULES button 32, a 1-BET switch 57 annexed to a BET 1 PER LINE button 33, a 3-BET switch 58 annexed to a BET 3 PER LINE button 34, a 5-BET switch 59 annexed to a BET 5 PER LINE button 35, a WIN•START switch 47 annexed to a WIN START FEATURE button 36, a 1-LINE switch 60 annexed to a PLAY 1 LINE button 37, a 5-LINES switch 61 annexed to a PLAY 5 LINES button 38, a 20-LINES switch 62 annexed to a PLAY 20 LINES button 39, and a GAMBLE•RESERVE switch 48 annexed to a GAMBLE RESERVE button 40. The CPU 50 will control all individual operations corresponding to each of these buttons based on switch signals outputted from each of the switches, when these buttons are depressed.

Further, the CPU 50 is connected with the coin sensor 49 arranged at the coin insertion part 9 and the bill sensor 67 arranged at the bill insertion part 10. The coin sensor 49 detects coins inserted from the coin insertion part 9, and the CPU 50 calculates the number of inserted coins on the basis of coin detection signals output from the coin sensor 49. The bill sensor 67 detects types and amounts of bills inserted from the bill insertion part 10, and the CPU 50 calculates the number of credits equivalent in value to bills on the basis of bill detection signals outputted from the bill sensor 67.

The hopper 71 is connected via a hopper driving circuit 70 to the CPU 50. When a driving signal is outputted from the CPU 50 to the hopper driving circuit 70, the hopper 71 pays out a predetermined number of coins from the coin payout slot 15.

Further, the coin detecting part 73 is connected via a payout completion signal circuit 72 to the CPU 50. The coin detecting part 73 is arranged inside the coin payout slot 15. When a predetermined number of coins are detected to be paid out from the coin payout slot 15, a coin payout detection signal is outputted from the coin detecting part 73 to the payout completion signal circuit 72, and the payout completion signal circuit 72 outputs a payout completion signal to the CPU 50. In addition, the CPU 50 is connected to the upper liquid crystal display 3 and the lower liquid crystal display 4 via a liquid-crystal driving circuit 74, and the CPU 50 controls the upper liquid crystal display 3 and the lower liquid crystal display 4.

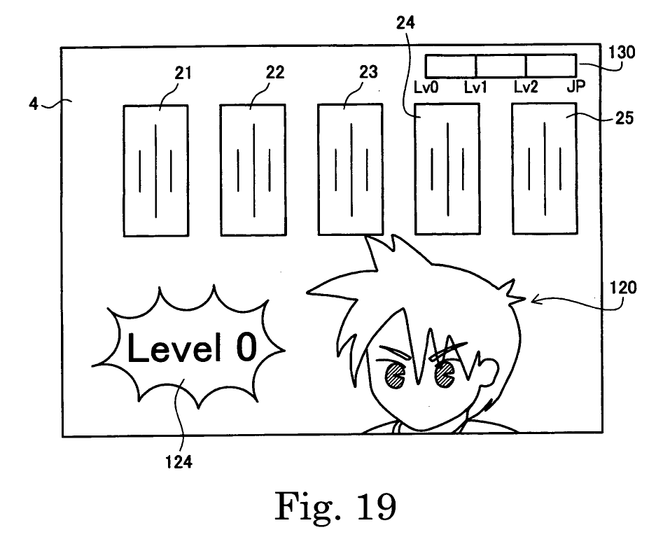

In this instance, the liquid-crystal driving circuit 74 is constituted of a program ROM, an image ROM, an image controlling CPU, a work RAM, a VDP (video display processor), a video RAM and the like. Then, the program ROM stores image controlling programs about the displayed images on the upper liquid crystal display 3 and the lower liquid crystal display 4, and various kinds of selection tables. The image ROM stores dot data for forming images such as the first reel band 111 through the fifth reel band 115 displayed on the lower liquid crystal display 4 (or variable display parts 21 through 25) and effect images corresponding to the game level set at the moment (refer to FIGS. 19 to 22).

Further, the CPU 50 is connected to a LED 78 via a LED driving circuit 77. Many LEDs 78 are disposed in front of the slot machine 101A and controlled for lighting by the LED driving circuit 77 on the basis of driving signals from the CPU 50, when various kinds of effects are provided. In the slot machine 101A of the first embodiment in particular, the LED 78 is lit for showing the effects in the bonus game or the like.

Further, a sound output circuit 79 and the speakers 5L and 5R are connected to the CPU 50, and the speakers 5L and 5R reproduce voices and effect sounds when various kinds of effects are provided on the basis of output signals from the sound output circuit 79. In the slot machine 101A of the first embodiment in particular, sounds are outputted for notifying the current game level during the advance notification effect to be performed at a predetermined probability when the symbols are variably displayed.

Still further, a communications circuit 63 is connected to the CPU 50. The communications circuit 63 is means for communicating with the server 102, sending necessary data to the server 102 and receiving data having been sent from the server 102 at a predetermined timing.

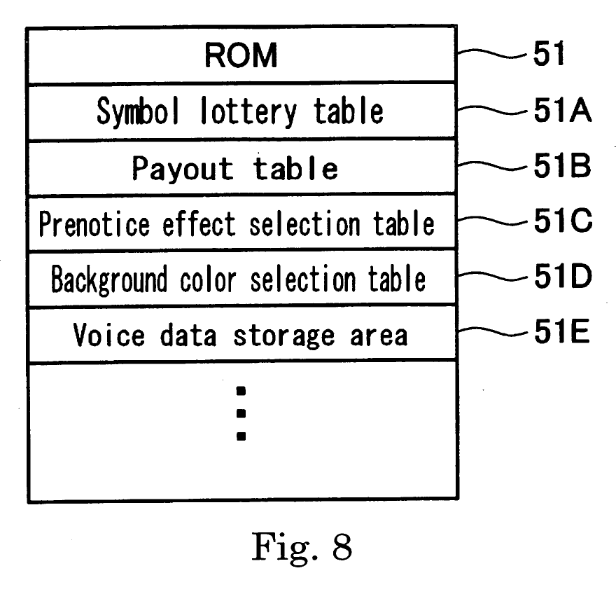

In addition, as illustrated in FIG. 8, the ROM 51 stores a symbol lottery table 51A for determining the symbols to be stopped and displayed respectively at the stop display areas, 211 through 213, 221 through 223, 231 through 233, 241 through 243 and 251 through 253 in variable display parts 21 through 25 (refer to FIG. 3) based on random numbers, a payout table 51B for storing winning combinations of symbols being stopped and displayed at the respective stop display areas and payout rates thereof, an advance notification effect selection table 51C to be used for selecting the advance notification effect provided when the symbols are variably displayed in the slot machine 101A based on the game level set at the moment (refer to FIG. 12), a background color selection table 51D to be used for selecting a background color of the lower liquid crystal display 4 of the slot machine 101A based on the game level set at the moment (refer to FIG. 13) and an audio data storage area 51E in which audio data of characters to be outputted from speakers 5L and 5R at the time of providing the effect is stored. A detailed explanation will be made later for the advance notification effect selection table 51C, the background color selection table 51D and the advance notification effect provided when the symbols are variably displayed.

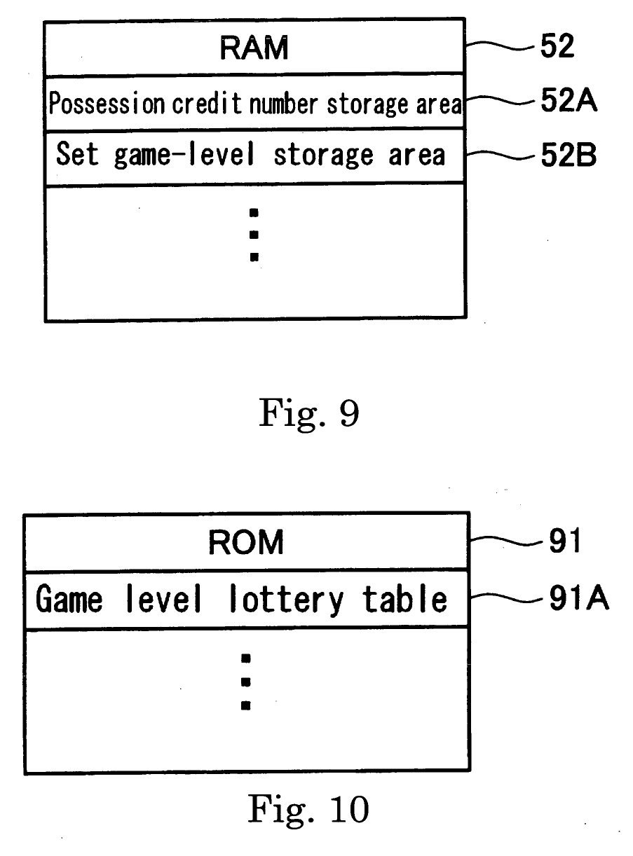

As illustrated in FIG. 9, there are provided a possession credit number storage area 52A for storing the credit number the player currently has and a set game-level storage area 52B for storing the currently set game level of the slot machine 101A among “level 0,” “level 1,” “level 2” and “level 3”.

In the above description, the control system of the slot machine 101A is described in particular. However, each of the slot machines 101B through 101E has a similar control system to that of the slot machine 101A.

As illustrated in FIG. 7, the control system of the server 102 which constitutes the gaming system 100 is basically composed of a CPU 90, which is a core component, and the CPU 90 is connected to a ROM 91 and a RAM 92. The ROM 91 stores a main processing program to be explained later, a game level lottery processing program, a game level lottery table for performing a lottery to select the game level in each of the connected slot machines 101A, 101B, 101C, 101D, 101E (refer to FIG. 14), and other programs and data tables necessary for controlling the server 102. Further, the RAM 92 is a memory for temporarily storing the cumulative amount of the JP so far, management data for managing the game level and winning status of each of the connected slot machines 101A, 101B, 101C, 101D, 101E and various kinds of data calculated by the CPU 90.

Further, the CPU 90 is connected to the clock pulse generating circuit 93 for generating a reference clock pulse and a frequency divider 94, and also connected to a random number generator 95 for generating random numbers and a random number sampling circuit 96. Random numbers sampled by the random number sampling circuit 96 are used in lotteries for changing the game level at each of the slot machines 101A, 101B, 101C, 101D, 101E.

In addition, a liquid-crystal driving circuit 97 is connected to the CUP 90, and the external liquid crystal display 103 is connected to the liquid-crystal driving circuit 97. Then, the CPU 90 controls the external liquid crystal display 103. In this instance as described, the external liquid crystal display 103 is installed on a wall located, for example, above an area where the slot machines 101A, 101B, 101C, 101D, 101E are installed, displaying the amount of JP having been accumulated so far in the RAM 92 of the server 102.

In this instance, as with the liquid-crystal driving circuit 74, the liquid-crystal driving circuit 97 is constituted of a program ROM, an image ROM, an image control CPU, a work RAM, a VDP and a video RAM and the like. Then, the program ROM stores image controlling programs on displays by an external liquid crystal display 103 and other various selection tables. The image ROM stores dot data for forming images which indicate, for example, the amount of JP displayed on the external liquid crystal display 103 (refer to FIG. 15).

A communications circuit 98 is connected to the CPU 90. The communications circuit 98 is communications means for communicating with the slot machines 101A, 101B, 101C, 101D, 101E, sending necessary data to the slot machines 101A, 101B, 101C, 101D, 101E and receiving data having been sent from the slot machines 101A, 101B, 101C, 101D, 101E.

Further, as illustrated in FIG. 10, the ROM 91 stores a game level lottery table 91A for determining whether or not to change the game level having been set at the time of starting the game in each of slot machines 101A, 101B, 101C, 101D, 101E is changed on the basis of random number values (refer to FIG. 14). A detailed explanation will be made later for the game level lottery table 91A.

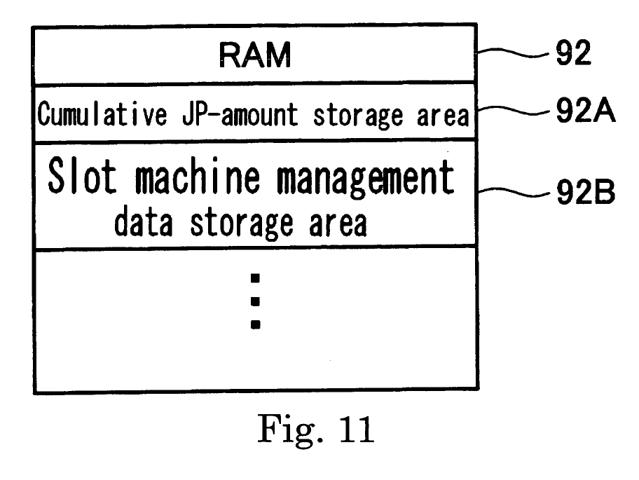

As illustrated in FIG. 11, the RAM 92 is provided with a cumulative JP-amount storage area 92A for storing the amount of JP accumulated so far is stored and a slot machine management data storage area 92B for storing the management data for managing the game level of each of the slot machines 101A, 101B, 101C, 101D, 101E and a winning status thereof based on the game result sent from each of the slot machines 101A, 101B, 101C, 101D, 101E after completion of the game.

Next, an explanation will be made for an advance notification effect selection table 51C which is stored in a ROM 51 of the slot machine 101A. FIG. 12 is a drawing showing the advance notification effect selection table 51C of the first embodiment.

The advance notification effect selection table 51C is a table used for selecting the advance notification effect performed at a predetermined percentage during variable display of the symbols in the five variable display parts 21 through 25 in the base game mode in the slot machine 101A. In this instance, in the slot machine of the first embodiment, the advance notification effect is performed at a predetermined probability to preliminarily notify the probability to obtain the bonus game (e.g., four or more symbols of “SARDINE” are stopped and displayed) in the game concerned during the variable display of the symbols. In particular, the advance notification effect is performed with images and sounds corresponding to the game level currently set in the slot machine 101A.

As illustrated in FIG. 12, by way of example, an explanation will be made for a case where “level 0” is set as the game level in the slot machine 101A. On the lower liquid crystal display 4, the advance notification effect is performed with a character of “man (normal or plain)” so as to show a male image 120 wearing ordinary clothes (refer to FIG. 19) and announce “level 0” in a male voice from speakers 5L and 5R.

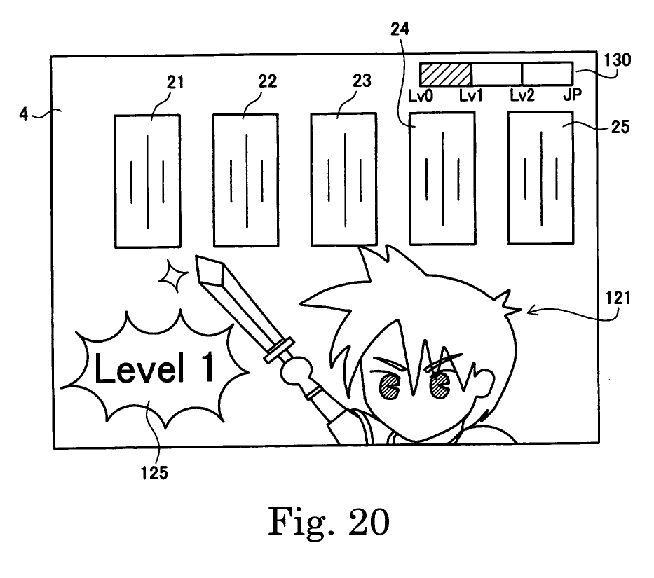

Further, an explanation will be made for a case where “level 1” is set as the game level in the slot machine 101A. On the lower liquid crystal display 4, the advance notification effect is performed with a character of “man (having a sword)” so as to show a male image 121 being dressed in the armor and having a sword (refer to FIG. 20) and announce “level 1” in a male voice from the speakers 5L and 5R.

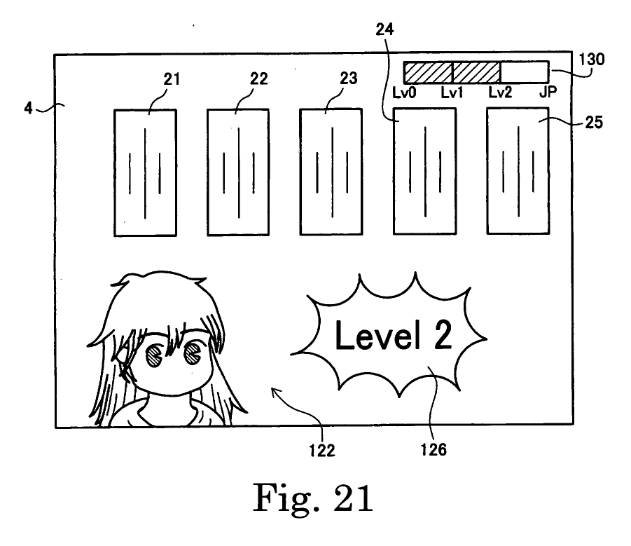

Still further, an explanation will be made for a case where “level 2” is set as the game level in the slot machine 101A. On the lower liquid crystal display 4, the advance notification effect is performed with a character of “woman (normal or plain)” so as to show a female image 122 wearing ordinary clothes (refer to FIG. 21) and announce “level 2” in a female voice from the speakers 5L and 5R.

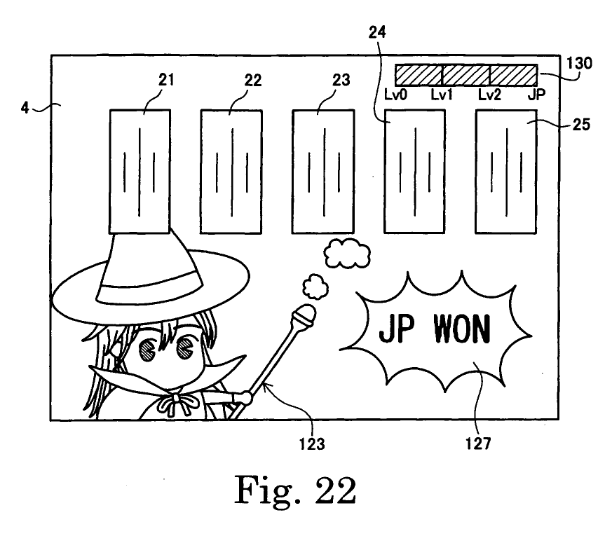

In addition, an explanation will be made for a case where “level 3” is set as the game level in the slot machine 101A, namely, the JP is won. On the lower liquid crystal display 4, an effect for notifying that the JP has been won is performed without fail by using a character of “woman (having a stick)” so as to show a female image 123 wearing a hat and cloak and having a stick (refer to FIG. 22) and announce “congratulations!” in a female voice from the speakers 5L and 5R.

Next, an explanation will be made for a background color selection table 51D which is stored in the ROM 51 of the slot machine 101A. FIG. 13 is a drawing illustrating the background color selection table 51D of the first embodiment.

The background color selection table 51D is used for selecting a color tone of the background color for an effect image displayed on the lower liquid crystal display 4 when five variable display parts 21 through 25 are used to conduct the base game in the slot machine 101A. In this instance, in the slot machine of the first embodiment, the background color of the effect image is determined based on color tone corresponding to the game level currently set in the slot machine 101A.

As illustrated in FIG. 13, an explanation will be made, for example, for a case where “level 0” is set to the game level in the slot machine 101A. In this instance, various effects are provided with the background blue color.

Further, an explanation will be made for a case where “level 1” is set to the game level in the slot machine 101A. In this instance, various effects are provided with the background green color.

Still further, an explanation will be made for a case where “level 2” is set to the game level in the slot machine 101A. In this instance, various effects are provided with the background yellow color.

In addition, an explanation will be made for a case where “level 3” is set to the game level in the slot machine 101A, that is, the case where the JP is won. In this instance, various effects are provided with the background red color.

Therefore, the player and people around each slot machine are able to recognize the game level currently set in each of the slot machines 101A, 101B, 101C, 101D, 101E because of display contents such as images (including the background color) shown on the lower liquid crystal display 4 and sounds outputted from speakers 5L and 5R. The player is also able to play the game as the player enjoys various advance notification effects and background colors corresponding to each game level. Further, in one of the slot machines 101A, 101B, 101C, 101D, 101E where the game level is set high, the player and people around the one of the slot machines 101A, 101B, 101C, 101D, 101E are able to anticipate that the JP may be won soon such that the play has more incentive to continue to play the game.

Next, an explanation will be made for the game level lottery table 91A stored in the ROM 91. FIG. 14 is a drawing illustrating the game level lottery table 91A of the first embodiment.

The game level lottery table 91A is a table used for determining whether to change the currently set game level with each of the slot machines 101A, 101B, 101C, 101D, 101E whenever the game is started in each of the slot machines 101A, 101B, 101C, 101D, 101E. More specifically, based on the currently set game level and a random number sampled from 0 to 499 by the random number sampling circuit 56, the lottery is conducted to determine whether to change the game level as described below.

In the case where the game level set currently in any one of the slot machines 101A, 101B, 101C, 101D, 101E in which a game is “level 0,” the game level is determined to be increased to become “level 3,” such that the JP is won if the sampled random number value is 0. Further, the game level is determined to be increased to become “level 2,” if the sampled random number value is in the range from 1 to 10. In addition, the game level is determined to be increased to become “level 1,” if the sampled random number value is in the range from 11 to 110. The game level is judged not to be advanced, if the sampled random number value is in the range from 111 to 499.

Further, where the game level set at present in any one of the slot machines 101A, 101B, 101C, 101D, 101E is “level 1,” the game level is determined to be increased to become “level 3,” such that the JP is won, if the sampled random number value is in the range from 0 to 9. The game level is determined to be increased to become “level 2,” if the sampled random number value is in the range from 10 to 109. The game level is determined not to be increased, if the sampled random number value is in the range from 110 to 499.

In addition, where the game level set currently in any one of the slot machines 101A, 101B, 101C, 101D, 101E is “level 2,” the game level is determined to be increased to become “level 3,” such that the JP is won, if the sampled random number value is in the range from 0 to 99. The game level is determined not to be advanced, if the sampled random number value is in the range from 100 to 499.

Then, the determination result is sent to the corresponding one of the slot machines 101A, 101B, 101C, 101D, 101E. The game level is renewed in such a slot machine 101A, 101B, 101C, 101D or 101E based on the thus sent determination result, and image effects and other effects may be performed according to thus set game level. It is noted that any one of the slot machines 101A, 101B, 101C, 101D, 101E, in which the game level is increased to become “level 3,” is to have the reset game level of “level 0” when the game is started again.

In this instance, the probability at which the game level is increased to become “level 3,” such that the JP is won, may vary depending on the game level set currently in any one of the slot machines 101A, 101B, 101C, 101D, 101E. More specifically, the probability to wind the JP is 1/500 if the game level is “level 0,” it is 1/50 if the game level is “level 1,” and it is 1/5 if the game level is “level 2.” As a result, the higher the game level is set in one of the slot machines 101A, 101B, 101C, 101D, 101E, the greater the probability is to win the JP. Therefore, the player plays the game, with an more increased anticipation to wind the JP, in any one of the slot machines 101A, 101B, 101C, 101D, 101E if the game level is set higher.

Next, an explanation will be made for a display screen 107 displayed on the external liquid crystal display 103 connected to the server 102. FIG. 15 is a drawing illustrating the display screen 107 of the external liquid crystal display 103 in the first embodiment.

In the display screen of the external liquid crystal display 103, a JP amount display part 108 indicating the JP amount (credit number) currently stored in the cumulative JP amount storage area 92A of RAM 92 of the server 102. Therefore, each player playing the game with each of the slot machines 101A, 101B, 101C, 101D, 101E and people around the slot machines 101A, 101B, 101C, 101D, 101E can recognize the credit number such that they would have more incentive to play the game.

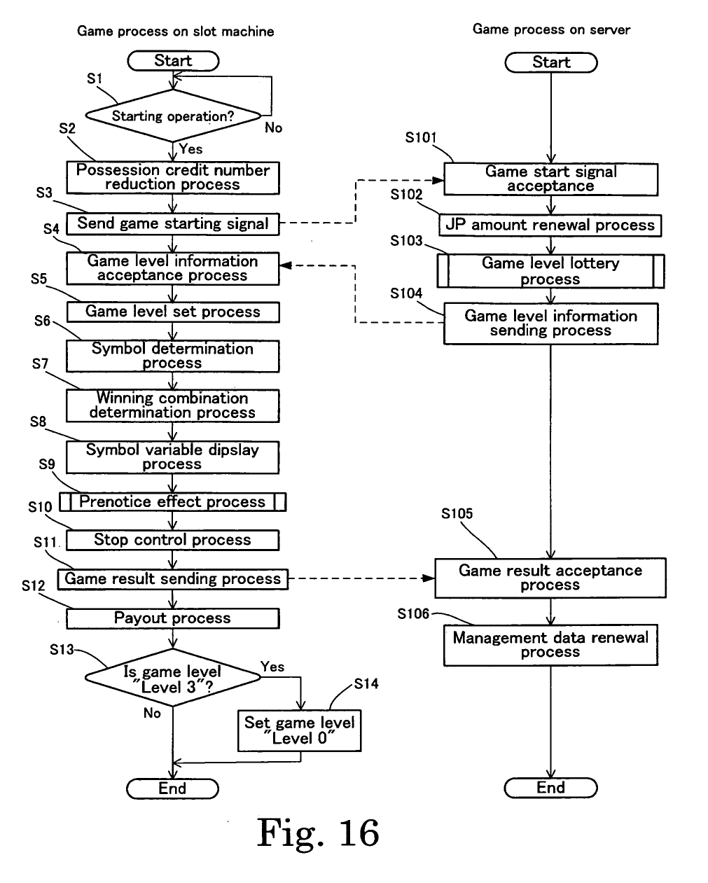

Next, an explanation will be made for a game processing program on the slot machine side executed by the CPU 50 for controlling the slot machines 101A, 101B, 101C, 101D, 101E and a game processing program on the server side executed by the CUP 90 for controlling the server 102 in the gaming system 100 of the above-mentioned first embodiment by referring to FIG. 16. These programs indicated in the flow chart of FIG. 16 are stored in the ROM 51 and the RAM 52 provided to each of the slot machines 101A, 101B, 101C, 101D, 101E or the ROM 91 and the RAM 92 provided to the server 102, and executed by the CPU 50 for controlling the slot machines or the CPU 90 for controlling the server. Here, in the flow chart on the slot machine side in FIG. 16, although all the slot machines 101A, 101B, 101C, 101D, 101E are recited, the program is explained with respect to the slot machine where the game processing program is conducted in the following description.

First, an explanation will be made for the game processing program on the side of the slot machines 101A, 101B, 101C, 101D, 101E by referring to FIG. 16. In a step (hereinafter, abbreviated as “S”) 1, it is determined whether a starting operation of the game is conducted or not. More specifically, it is determined that the game is started if switch signals having been outputted from the 1-BET switch 57, the 3-BET switch 58, the 5-BET switch 59, the 1-LINE switch 60, the 5-LINES switch 61, the 20-LINES switch 62 on the basis of an operation of the BET 1 PER LINE button 33, that of the BET 3 PER LINE button 34, that of the BET 5 PER LINE button 35, that of the PLAY 1 LINE button 37, that of the PLAY 5 LINES button 38 and that of the PLAY 20 LINES button 39 under the condition that the number of credits stored in the possession credit number storage area 52A of the RAM 52 is at least 1.

Then, when it is determined that the starting operation of the game is not conducted (S1: NO), the program waits until the starting operation is conducted, and when it is determined that the starting operation is conducted (S1: YES), the number of credits consumed (bet) in S2 is deducted from the possession credit number storage area 52A.

In S3, a game start signal which indicates that the game is started at any one of the slot machines 101A, 101B, 101C, 101D, 101E is sent to the server 102. A signal which indicates the number of credits consumed (bet) in the current game is also sent to the server 102. Accordingly, in the server 102, some quota is added to the amount of the JP and the lottery is conducted to determine whether to increase the game level in a starting slot machine of the slot machines 101A, 101B, 101C, 101D, 101E (S102 and S103) as described later.

Then, in S4, game level information is received, which is sent from the server 102. In this instance, the game level information is about the renewed game level of the slot machine concerned among the slot machines 101A, 101B, 101C, 101D, 101E (for example, the game level of “No. 3” (identification number to identify the connected slot machine 101C) has been lifted up from “level 1” to “level 2” and so on) and the game level information is sent, irrespective of whether the game level is increased or not based on the lottery result to determine the game level in the server 102.

Next, in S5, the game level is renewed in such one of the slot machines 101A, 101B, 101C, 101D, 101E on the basis of the game level information received in the S4. More specifically, the renewed game level is stored in the set game-level storage area 52B (any of “level 0,” “level 1,” “level 2” or “level 3”). And display contents of the level display part 130 (refer to FIGS. 19-22) are renewed according to the renewed game level.

Here, the level display part 130 is a display part for showing the level currently set to the slot machine 101A, 101B, 101C, 101D or 101E and it is easy to grasp visually which game level is currently set, “Level 0,” “Level 1,” or “Level 2” since the game level is expressed in a bar graph, which extends in the left-and-right direction. More specifically, if the length of the bar graph is zero (0), it is indicated that the game level of the slot machine is set “Level 0.” And if the length of the bar graph extends for two segments, it is indicated that the game level of the slot machine is set “Level 2.” And if the length of the bar graph extends to the maximum, it is indicated that the game level of the slot machine is set “Level 3,” i.e., that the JP is won.

Further, in S6, a symbol determination process is conducted. In this instance, in the base game, symbols stopped and displayed in the first winning line L1 is determined for each of variable display parts 21 through 25. More specifically, as described previously, five corresponding random number values for each of the variable display parts 21 through 25 are sampled by the random number sampling circuit 56 to determine code numbers by referring to the symbol lottery table 51A. In addition, on the basis of the code numbers and a first reel band 111 through a fifth reel band 115, symbols stopped and displayed are determined for each of the variable display parts 21 through 25.

Then, in S7, a winning combination determination process is conducted upon determination of symbols which are to be stopped and displayed on an activated winning line. In the winning combination determination process, the winning combination and the payout rate are determined on the basis of the symbols having been determined in the S6 and the payout table 51B.

Thereafter, in S8, individual symbols are scrolled in the variable display parts 21 through 25 on the basis of switch signals which are outputted from the 1-LINE switch 60, the 5-LINES switch 61 and the 20-LINES switch 62 and received in the S1.

Further, in S9, while symbols are variably displayed before they are stopped in the variable display parts 21 through 25, an advance notification effect process is conducted at a predetermined probability, which generates an advance notification effect to notify a winning of the bonus game. The advance notification effect process will be explained in detail later.

Thereafter, in the variable display parts 21 through 25 in which symbols are being scrolled, each of the scrolling symbols is stopped (S10). Then, in S11, the game result of the current game (whether any winning combination is won or not) is sent to the server 102.

Further, in S12, a credit amount corresponding to the payout determined by the payout table 51B is paid out, according to a winning combination of symbols stopped and displayed in the respective variable display parts 21 through 25 in the S10. When the game level information that the game level has been increased to become “level 3” such that the JP is won is received from the server 102 in the S4, the credit amount corresponding to the amount stored in the cumulative JP-amount storage area 92A of the RAM 92 is paid out to the player. The paid out credit amount is stored in the possession credit number storage area 52A. Thereafter, upon depression of the COLLECT button 31, coins equivalent in value to the number of credits to be stored are paid out to the coin receiving part 16 from the coin payout slot 15 via the hopper 71 provided inside each of the slot machines 101A, 101B, 101C, 101D, 101E.

In addition, in S13, it is determined whether the game level currently set is “level 3” or not, that is, it is determined whether the server 102 instructs that the JP has been won in this game or not. When the game level currently set is “level 3,” the game level to be renewed in the slot machines 101A, 101B, 101C, 101D, 101E is set to be “level 0.” Then, the game process with respect to the current game is completed.

In the current game, where the bonus game is won (four or more of “SARDINE” are stopped and displayed at the same time, irrespective of the activated winning lines in the variable display parts 21 through 25), the game process of the bonus game including a predetermined number of free games is carried out after completion of the game process of base games in the S1 through S13. Any kinds of bonus games may be applied to the game process of the bonus game and that the detailed explanation is omitted here.

Next, an explanation will be made for the game processing program on the server 102 in referring to FIG. 16. First, in S101, the game start signal is received, which has been sent from one or more of the slot machines 101A, 101B, 101C, 101D, 101E in the S3. Further, the server 102 receives a signal which instructs the number of credits consumed (bet) in the current game by concerned one of the slot machines 101A, 101B, 101C, 101D, 101E having sent the game start signal as well as the game start signal.

In S102, the amount of the JP is renewed on the basis of the number of credits received in the S101. More specifically, the number of credits corresponding to 1% of the number of credits newly consumed (bet) in one or more of the slot machines 101A, 101B, 101C, 101D, 101E (for example, 2 credits where 200 credits are bet) is added to the number of credits in the cumulative JP-amount storage area 92A. Further, the server 102 renews the number of credits in the JP-amount display part 108 displayed on the display screen 107 of the external liquid crystal display 103 (refer to FIG. 15).

Then, in S103, an internal lottery is conducted based on the random number values used in the S101. The game level lottery process to be explained later is conducted in order to determine whether to increase the game level in one or more of the slot machines 101A, 101B, 101C, 101D, 101E having received the game start signal. The game level lottery process will be explained later in detail.

Then, in S104, the game level information based on the game level lottery process in the S103 is sent to concerned one or more of the slot machines 101A, 101B, 101C, 101D, 101E having received the game start signal. In this instance, the game level information is information about the game level renewed in each of the slot machines 101A, 101B, 101C, 101D, 101E in which the game is started (for example, the game level of “No. 3” (identification number to identify the connected slot machine 101C) has been lifted up from “level 1” to “level 2” and so on) and the game level information is sent, irrespective of whether the game level is increased or not. In this instance, in particular, when the game level information that the game level is increased to become “level 3” is sent, the current amount of the JP stored in the cumulative JP-amount storage area 92A is also sent to instruct the payout thereof.

Further, in S105, the server 102 receives information about the game result of this game in the concerned one or more of the slot machines 101A, 101B, 101C, 101D, 101E (whether any winning combination is won or not). Thereafter, management data stored in the slot machine management data storage area 92B is renewed on the basis of this game in the concerned slot machine (S106). In this instance, the current game level, the winning probability of the JP, the payout percentage and the like for each of the five connected slot machines 101A, 101B, 101C, 101D, 101E are stored in the management data. Data on the winning probability of the JP and the payout percentage are renewed on the basis of the game result received in the S105. Where any one of the slot machines 101A, 101B, 101C, 101D, 101E having been determined to have the game level of “level 3” (the JP is won) in the S103, the game level of the corresponding slot machine is renewed to be “level 0.” Then, the game process concerned is completed.

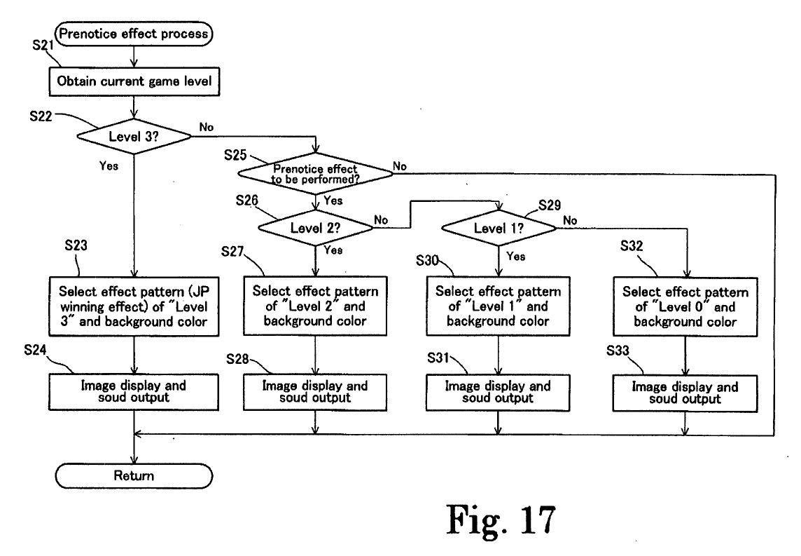

Next, an explanation will be made for a sub process of “advance notification effect process” in the S9. FIG. 17 is a sub flow chart illustrating the sub process of the “advance notification effect process” carried out by the CPU 50 in each of the slot machines 101A, 101B, 101C, 101D, 101E in this embodiment.

In the advance notification effect process, first, in S21, the CPU 50 obtains the current game level set in the S5 for concerned one of more of the slot machines 101A, 101B, 101C, 101D, 101E from the set game-level storage area 52B of the RAM 52.

Thereafter, in S22, it is determined whether the game level obtained in the S21 is “level 3” or not. Then, when the game level is determined to be “level 3” (S22: YES), contents of the effect and the background color corresponding to “level 3” (S23) are selected on the basis of the advance notification effect selection table 51C (refer to FIG. 12) and the background color selection table 51D (refer to FIG. 13). An image is displayed on the lower liquid crystal display 4 according to the selected contents, and sounds are outputted from speakers 5L and 5R, thereby providing an effect to notify that the JP is won (S24). In this instance, FIG. 22 illustrates a display screen for the effect of the JP winning displayed on the lower liquid crystal display 4 when the game level becomes “level 3” such that the JP is won in any one of the slot machines 101A, 101B, 101C, 101D, 101E.

As illustrated in FIG. 22, where the JP is won, a female image 123 wearing a hat and cloak and having a stick is displayed for about 2 seconds and a phrase of “congratulations!” is also outputted in a female voice from the speakers 5L and 5R. A character string 127 of “JP WON” is displayed on the lower liquid crystal display 4. Further, the background red color is used in the background image in the lower liquid crystal display 4.

On the other hand, when it is determined that the game level is not “level 3” (S22: NO), it is determined whether or not to perform an advance notification effect during the variable display of the symbols. In this instance, it is determined whether to perform the advance notification effect is provided or not by an internal lottery to be conducted independently in the concerned one or more of the slot machines 101A, 101B, 101C, 101D, 101E. Then, when it is determined that the advance notification effect is to be performed (S25: YES), the process proceeds to S26. However, when it is determined that the advance notification effect is not performed (S25: NO), the advance notification effect process concerned is completed.

Further, in the S26, it is determined whether the game level obtained in the S21 is “level 2” or not. Then, when it is determined that the game level is “level 2” (S26: YES), contents of the effect and the background color corresponding to “level 2” (S27) are selected on the basis of the advance notification effect selection table 51C (refer to FIG. 12) and the background color selection table 51D (refer to FIG. 13). The image is displayed on the lower liquid crystal display 4 according to the selected contents, and sounds are outputted from the speakers 5L and 5R, thereby providing an advance notification effect (S28). In this instance, FIG. 21 illustrates a display screen for the advance notification effect displayed on the lower liquid crystal display 4 when the game level is “level 2” in the concerned one or more of the slot machines 101A, 101B, 101C, 101D, 101E.

As illustrated in FIG. 21, as the advance notification effect is conducted in a state that the game level is “level 2,” a female image 122 wearing ordinary clothes is displayed for about 2 seconds, and a phrase “level 2” is also outputted in a female voice from the speakers 5L and 5R. A character string 126 of “Level 2” is displayed on the lower liquid crystal display 4. Further, the background yellow color is used in the background image of the lower liquid crystal display 4.

On the other hand, where the game level is determined not to be “level 2” (S26: NO), then, in S29, it is determined whether the game level obtained in the S21 is “level 1” or not. Then, when it is determined that the game level is “level 1” (S29: YES), contents of the effect and the background color corresponding to “level 1” (S30) are selected on the basis of the advance notification effect selection table 51C (refer to FIG. 12) and the background color selection table 51D (refer to FIG. 13). An image is displayed on the lower liquid crystal display 4 according to the selected contents, and sounds are outputted from the speakers 5L and 5R, thereby providing an advance notification effect (S31). In this instance, FIG. 20 illustrates a display screen for the advance notification effect displayed on the lower liquid crystal display 4 when the game level is “level 1” in the concerned one or more of the slot machines 101A, 101B, 101C, 101D, 101E.

As illustrated in FIG. 20, in providing the advance notification effect in a state that the game level is “level 1,” a male image 121 dressed in armor and having a sword is displayed for about 2 seconds, and a phrase “level 1” is also outputted in a male voice from the speakers 5L and 5R. A character string 125 of “level 1” is displayed on the lower liquid crystal display 4. Further, the background green color is used in the background image on the lower liquid crystal display.

Further, when it is determined that the game level is not even “level 1” (S29: NO) such that the game level obtained in the S21 is “level 0,” contents of then effect and the background color corresponding to “level 0” (S32) are selected on the basis of the advance notification effect selection table 51C (refer to FIG. 12) and the background color selection table 51D (refer to FIG. 13). An image is displayed on the lower liquid crystal display 4 according to the selected contents, and sounds are outputted from the speakers 5L and 5R, thereby providing an advance notification effect (S33). In this instance, FIG. 19 illustrates a display screen for the advance notification effect displayed on the lower liquid crystal display 4 when the game level is “level 0” in the concerned one or more of the slot machines 101A, 101B, 101C, 101D, 101E.

As illustrated in FIG. 19, when the advance notification effect in a state that a game level is “level 0” is performed, a male image 120 wearing ordinary clothes is displayed for about 2 seconds, and a phrase “level 0” is also outputted in a male voice from the speakers 5L and 5R. A character string 124 of “level 0” is displayed on the lower liquid crystal display 4. Further, a background color which is based on blue is used in the background image on the lower liquid crystal display 4. Then, the advance notification effect process concerned is completed.

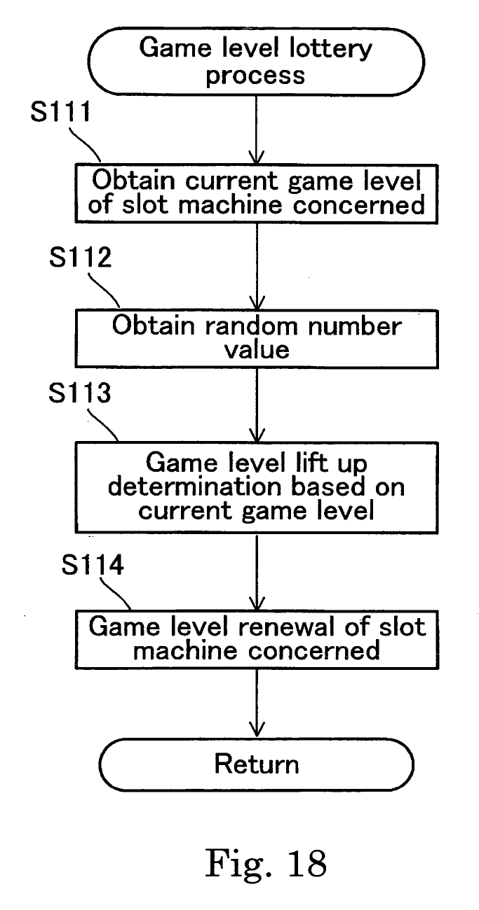

Next, an explanation will be made for a sub process of “game level lottery process” in the S103. FIG. 18 is a sub flow chart illustrating the sub process of the “game level lottery process” carried out by the CPU 90 of the server 102 in this embodiment.

In the game level lottery process, first, in S111, the game level currently set in one or more of the slot machines 101A, 101B, 101C, 101D, 101E for which the game start signal has been received in the S101 is obtained from management data stored in the slot machine management data storage area 92B.

Then, in S112, random number values are sampled in the range from 0 to 499 by the random number sampling circuit 96. Then, in S113, it is determined whether the game level of the concerned one or more of the slot machines 101A, 101B, 101C, 101D, 101E in which the game is started should be increased or not.

It is determined whether to increase the game level or not by referring to the game level lottery table 91A (refer to FIG. 14) on the basis of the game level set currently and obtained in the S111, and the random number values obtained in the S112.

For example, where the game level set currently is “level 0” and the obtained random number value is “80,” the game level of the concerned one of the slot machines 101A, 101B, 101C, 101D, 101E is determined to become from “level 0” to “level 1.” Further, where the game level set currently is “level 2” and the obtained random number value is “338,” the game level of the concerned one the slot machines 101A, 101B, 101C, 101D, 101E is determined to remain at “level 2.”

Next, management data stored in the slot machine management data storage area 92B is renewed on the basis of the lottery result of the game level of the concerned one of the slot machines 101A, 101B, 101C, 101D, 101E (S114). In this instance, the current game level, the winning probability of the JP, the payout percentage and the like are stored in the management data for each of the five connected slot machines 101A, 101B, 101C, 101D, 101E. The game level is renewed in the slot machines 101A, 101B, 101C, 101D, 101E which are supposed to be renewed this time on the basis of the result of determination on whether the game level is increased or not in the S113. Then, the game level lottery process is completed.

As explained so far, in the gaming system 100 of the first embodiment, the game process is conducted by using an effect corresponding to the game level set currently in the concerned one or more of the slot machines 101A, 101B, 101C, 101D, 101E (S21 through S33), and in the server 102 the lottery is conducted to determine whether to change the current game level as the game is started in the concerned one or more of the connected slot machines 101A, 101B, 101C, 101D, 101E (S111 through S114). Then, in particular, where it is determined by the server 102 that the game level should be increased to become “level 3,” instructions are given to the concerned one of the slot machines 101A, 101B, 101C, 101D, 101E that the JP is won (S104) and the concerned one of the slot machines 101A, 101B, 101C, 101D, 101E pays out a credit amount equivalent in value to the current amount of the JP stored in the cumulative JP-amount storage area 92A (S12) Therefore, the player is able to enjoy various types of games as the player may have an increased anticipation for winning the JP.

Further, since the game can be played in accordance with various effect patterns corresponding to the game level set currently, the player may not be bored of the game but able to play various types of games.

Still further, since the game level set currently in the slot machine is shown in the display part 130 of the lower liquid crystal display 4 thereof, the player currently playing the game in one of the slot machines 101A, 101B, 101C, 101D, 101E and a person who may start to play the game with one of the slot machines 101A, 101B, 101C, 101D, 101E can easily recognize the game level set currently in the one of the slot machines 101A, 101B, 101C, 101D, 101E. Therefore, they can play the game, with an increased anticipation for higher possibility to win the jackpot.

In addition, since the same game state based on the game level (for example, “level 2”) which affects the occurrence probability of the jackpot can be kept from one game to another game, the player now playing the game with any one of the slot machines 101A, 101B, 101C, 101D, 101E is motivated to continue to play the game and those who may start to play the game with any one of the slot machines 101A, 101B, 101C, 101D, 101E have more incentive to play the game.

### Second Embodiment

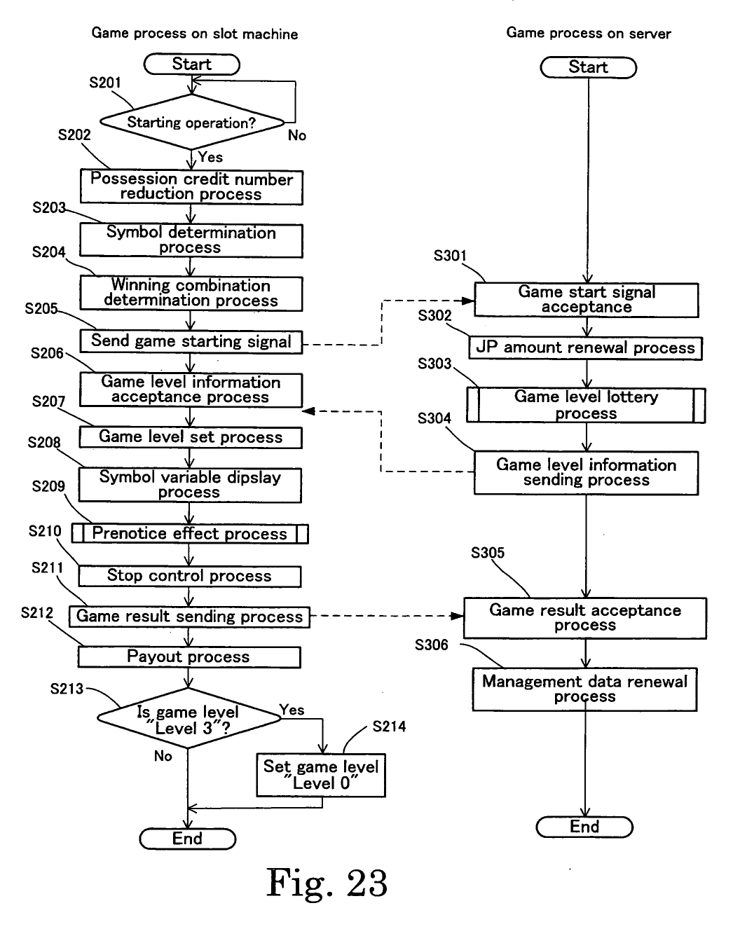

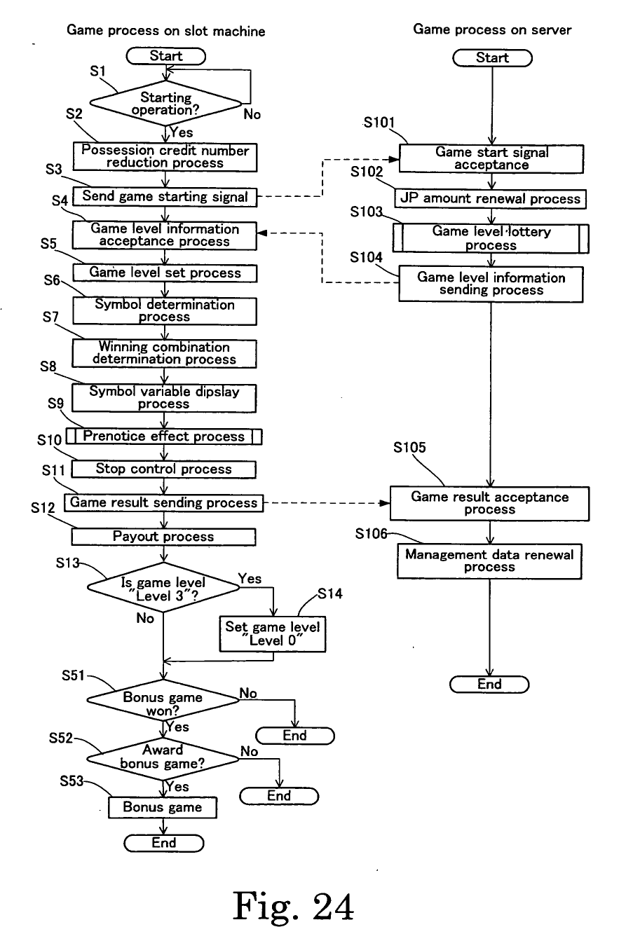

Next, an explanation will be made for a gaming system of a second embodiment in referring to FIG. 23. In the following explanation, symbols which are the same as those used in explaining the configuration of the gaming system 100 of the first embodiment in FIGS. 1 to 22 are to indicate the same or corresponding elements in the configuration of the gaming system 100 of the first embodiment.

The gaming system of the second embodiment is almost the same in the configuration of the gaming system 100 of the first embodiment. Further, various control processes are also almost the same as those in the gaming system 100 of the first embodiment.

In the gaming system 100 of the first embodiment, before the lottery process for the base slot game is conducted in any one of the slot machines 101A, 101B, 101C, 101D, 101E (S6 to S7), the lottery process to determine the game level is conducted in the server 102 (S103) to obtain the renewed game level (S5). On the other hand, in the gaming system of the second embodiment, the lottery process for the base slot game is first conducted in any one of the slot machines 101A, 101B, 101C, 101D, 101E, and then, the lottery process to determine the a game level is conducted in the server 102 to obtain a renewed game level. In this point, the gaming system 100 of the second embodiment is different from the gaming system 100 of the first embodiment.

Hereinafter, an explanation will be made for a game processing program on the slot machine side executed by the CPU 50 for controlling concerned one or more of the slot machines 101A, 101B, 101C, 101D, 101E and a game processing program on the server side executed by the CUP 90 for controlling the server 102 in the gaming system of the second embodiment in referring to FIG. 23. These programs indicated in the flow chart of FIG. 23 are stored in the ROM 51 and the RAM 52 provided on the respective slot machines 101A, 101B, 101C, 101D, 101E or the ROM 91 and the RAM 92 provided on the server 102, and executed by the CPU 50 for controlling the slot machines or the CPU 90 for controlling the server.

First, an explanation will be made for the game processing program on the side of the slot machines 101A, 101B, 101C, 101D, 101E by referring to FIG. 23. In S201, it is determined whether a starting operation of the game is conducted or not. More specifically, it is determined that the game is started if switch signals having been outputted from the 1-BET switch 57, the 3-BET switch 58, the 5-BET switch 59, the 1-LINE switch 60, the 5-LINES switch 61, the 20-LINES switch 62 on the basis of an operation of the BET 1 PER LINE button 33, that of the BET 3 PER LINE button 34, that of the BET 5 PER LINE button 35, that of the PLAY 1 LINE button 37, that of the PLAY 5 LINES button 38 and that of the PLAY 20 LINES button 39 under the condition that the number of credits stored in the possession credit number storage area 52A of the RAM 52 is at least 1.

Then, when it is determined that the starting operation of the game is not conducted (S201: NO), the program waits until the starting operation is conducted, and when it is determined that the starting operation is conducted (S201: YES), the number of credits consumed (bet) in S2 is deducted from the possession credit number storage area 52A.

Further, in S203, a symbol determination process is conducted. In this instance, in the base game, symbols stopped and displayed in the first winning line L1 is determined for each of variable display parts 21 through 25. More specifically, as described previously, five corresponding random number values for each of the variable display parts 21 through 25 are sampled by the random number sampling circuit 56 to determine code numbers by referring to the symbol lottery table 51A. In addition, on the basis of the code numbers and a first reel band 111 through a fifth reel band 115, symbols stopped and displayed are determined for each of the variable display parts 21 through 25.

Then, in S204, a winning combination determination process is conducted upon determination of symbols which are to be stopped and displayed on an activated winning line. In the winning combination determination process, the winning combination and the payout rate are determined on the basis of the symbols having been determined in the S203 and the payout table 51B.

In S205, a game start signal which indicates that the game is started at any one of the slot machines 101A, 101B, 101C, 101D, 101E is sent to the server 102. A signal which indicates the number of credits consumed (bet) in the current game is also sent to the server 102. Accordingly, in the server 102, some quota is added to the amount of the JP and the lottery is conducted to determine whether to increase the game level in a starting slot machine of the slot machines 101A, 101B, 101C, 101D, 101E (S302 and S303) as described later.

Then, in S206, game level information is received, which is sent from the server 102. In this instance, the game level information is information about the renewed game level of the slot machine concerned among the slot machines 101A, 101B, 101C, 101D, 101E (for example, the game level of “No. 3” (identification number to identify the connected slot machine 101C) has been lifted up from “level 1” to “level 2” and so on) and the game level information is sent, irrespective of whether the game level is increased or not based on the lottery result to determine the game level in the server 102.

Next, in S207, the game level is renewed in such one of the slot machines 101A, 101B, 101C, 101D, 101E on the basis of the game level information received in the S206. More specifically, the renewed game level (any one of “level 0,” “level 1,” “level 2” or “level 3”) is stored in the set game-level storage area 52B and the display in the display part 130 provided on the lower liquid crystal display 4 (refer to FIGS. 19 to 22) is renewed according to the newly set game level.

Here, the following processes from S208 through S214 are basically the same as those in S8 through S14 (refer to FIG. 16) in the game processing program on the side of the slot machines 101A, 101B, 101C, 101D, 101E according to the first embodiment, the explanation of which will be omitted.

Next, an explanation will be made for the game processing program on the server 102 in referring to FIG. 23 according to the second embodiment. First, in S301, the game start signal is received, which has been sent from one or more of the slot machines 101A, 101B, 101C, 101D, 101E in the S205. Further, the server 102 receives a signal which instructs the number of credits consumed (bet) in the current game by concerned one of the slot machines 101A, 101B, 101C, 101D, 101E having sent the game start signal as well as the game start signal.

In S302, the amount of the JP is renewed on the basis of the number of credits received in the S301. More specifically, the number of credits corresponding to 1% of the number of credits newly consumed (bet) in one or more of the slot machines 101A, 101B, 101C, 101D, 101E (for example, 2 credits where 200 credits are bet) is added to the number of credits in the cumulative JP-amount storage area 92A. Further, the server 102 renews the number of credits in the JP-amount display part 108 displayed on the display screen 107 of the external liquid crystal display 103 (refer to FIG. 15).

Then, in S303, an internal lottery is conducted based on the random number values used in the S301. The game level lottery process to be explained later is also conducted in order to determine whether to increase the game level in one or more of the slot machines 101A, 101B, 101C, 101D, 101E having received the game start signal. Here, the game level lottery process is explained in referring to FIG. 18 such that the duplicated explanation is omitted.

Then, in S304, the game level information based on the game level lottery process in the S303 is sent to concerned one or more of the slot machines 101A, 101B, 101C, 101D, 101E having received the game start signal. In this instance, the game level information is information about the game level renewed in the slot machines 101A, 101B, 101C, 101D, 101E in which the game is started (for example, the game level of “No. 3” (identification number to identify the connected slot machine 101C) has been lifted up from “level 1” to “level 2” and so on) and the game level information is sent, irrespective of whether the game level is increased or not. In this instance, in particular, when the game level information that the game level is increased to become “level 3” is sent, the current amount of the JP stored in the cumulative JP-amount storage area 92A is also sent to instruct the payout thereof.

Here, the following processes from S305 through S306 are basically the same as those from S105 to S106 (refer to FIG. 16) in the game processing program on the side of the server 102 of the first embodiment such that the duplicated explanation is omitted.

As explained so far, in the gaming system 100 of the second embodiment, the game process is conducted by using an effect corresponding to the game level set currently in the concerned one or more of the slot machines 101A, 101B, 101C, 101D, 101E, and in the server 102 the lottery is conducted to determine whether to change the current game level as the game is started in the concerned one or more of the connected slot machines 101A, 101B, 101C, 101D, 101E. Then, in particular, where it is determined by the server 102 that the game level should be increased to become “level 3,” instructions are given to the concerned one of the slot machines 101A, 101B, 101C, 101D, 101E that the JP is won (S304) and the concerned one of the slot machines 101A, 101B, 101C, 101D, 101E pays out a credit amount equivalent in value to the current amount of the JP stored in the cumulative JP-amount storage area 92A (S212). Therefore, the player is able to enjoy various types of games as the player may have an increased anticipation for winning the JP.

Further, since the game can be played in accordance with various effect patterns corresponding to the game level set currently, the player may not be bored of the game but able to play various types of games.

Still further, since game level set currently in the slot machine is shown in this level display part 130 of the lower liquid crystal display 4 thereof, the player currently playing the game in one of the slot machines 101A, 101B, 101C, 101D, 101E and a person who may start to play the game with one of the slot machines 101A, 101B, 101C, 101D, 101E can easily recognize the game level set currently in the one of the slot machines 101A, 101B, 101C, 101D, 101E. Therefore, they can play the game, with an increased anticipation for higher possibility to win the jackpot.

In addition, since the same game state based on the game level (for example, “level 2”) which affects the occurrence probability of the jackpot can be kept from one game to another game, the player now playing the game with any one of the slot machines 101A, 101B, 101C, 101D, 101E is motivated to continue to play the game and those who may start to play the game with any one of the slot machines 101A, 101B, 101C, 101D, 101E have more incentive to play the game.

As a matter of course, the present invention is not limited to the above-described embodiments but may be improved or modified in various ways without departing the scope of the present invention.

For example, in the first and the second embodiments, the game level set in any one of the slot machines 101A, 101B, 101C, 101D, 101E is to be kept the same, even when the player is changed. However, the game level may be reset to become “level 0” after all credits stored are paid out upon depression of the COLLECT button 31.

Further, in the first and the second embodiments, the advance notification effect of the bonus game to be won is changed based on the game level set currently. However, other effects may be changed, irrespective of the advance notification effect of the bonus game.

For example, where the game level is set higher and “A-A-A-A-Q” is once displayed on an activated winning line, the effect image that the symbol of “Q”, which is finally stopped, is changed to the symbol of “A” to provide the player with a higher winning combination may be shown.

Further, the content of the bonus game may be changed according to the game level being set currently.

In addition, the symbol lottery table 51A for performing a lottery for a winning combination may be changed such that the winning combination can be easily obtained while the content of the effect remains.

FIG. 24 is a flow chart of a game processing program of the gaming system according to another embodiment of the present invention. FIG. 24 shows the same flows from S1 to S14 and S101 to S106 in FIG. 16. After S13 or S14, the process shifts to a determination step of the bonus game such that it is determined whether the bonus game has been won or not (S51). If the bonus game has not been won, then the game process on the slot machine is completed (Ended) and a new game may be restarted upon the starting operation (S1). If the bonus game has been won, the process shifts to a determination step of awarding the bonus game (S52).

If it is determined to award the bonus game, the process shifts to a bonus game routine (S53). Then, any kinds of bonus games such as a predetermined number of free games can be conducted (S53). After completion of the bonus game, the game process on the slot machine is completed (Ended) and a new game may be restarted upon the starting operation (S1).

If it is determined not to award the bonus game, the game process on the slot machine is completed (Ended) and a new game may be restarted upon the starting operation (S1). The determination step of awarding the bonus game (S52) is optional, but the step may be beneficial to adjust the total amount of payout since it may be determined not to award the bonus game to the player who has won the JP. Alternatively, it may be determined to award the bonus game to any player such that the player may eventually obtain a large amount of payout, thereby making the game more exciting. In such a case, the step S52 is removed.

In the embodiment as described above, a plurality of game levels is set to gaming terminals depending on a lottery result by a server, and the jackpot is won if the game level reaches a predetermined level and effect contents on the gaming terminals are changed depending on the game levels set on the respective gaming terminals such that a player may have more anticipation to the progressive function and that a variety of game contents, which entertain the player well, may be provided. Therefore, it is an object to provide a gaming system, gaming terminals and a server utilized in the gaming system, in which a variety of game with enhanced anticipation to win the jackpot by the player.

In the embodiment as described above, a gaming system (e.g., gaming system 100) comprises: a plurality of gaming terminals, wherein each gaming terminal includes: acceptance means (e.g., coin insertion part 9 and bill insertion part 10) for receiving game media; operation means (e.g., operation panel 8) for accepting the player's operation; notification means (e.g., lower liquid crystal display 4, speakers 5L, 5R) for conducting a predetermined notification; and payout means (e.g., CPU 50, S12) for paying out a predetermined value of game media based on the operation information of the operation means and a game result caused by the operation information; and a server (e.g., server 102) having cumulative storage means (e.g., cumulative JP amount storage area 92A) for storing cumulatively a predetermined portion of the game media received by the acceptance means in the plurality of gaming terminals, the server being connected to the plurality of gaming terminals in a communicable way, wherein the gaming terminal comprises: notification control means (e.g., CPU 50, S21-S33) for controlling the notification means based on the gaming state of the gaming terminal and game level-instruction information sent from the server; and cumulative game medium payout means (e.g., CPU 50, S12) for paying out a predetermined accumulated value of game media stored by the cumulative storage means based on the payout instruction information sent by the server, and wherein the server comprises: server game level setting means (e.g., CPU 90, S114) for setting a game level of the plurality of game levels to each of the plurality of gaming terminals; game level lottery means (e.g., CPU 90, S103) for conducting a lottery to determine whether to change the game levels set by the server game level setting means to the plurality of gaming terminals, respectively; game level instruction means (e.g., CPU 90, S104) for sending game level instruction information to instruct game levels to the plurality of gaming terminals based on a lottery result by the game level lottery means; game level determination means (e.g., CPU 90, S113) for determining whether to change the game level of the gaming terminal to a predetermined level; and cumulative game medium payout instruction means (e.g., CPU 90, S104) for sending the payout instruction information to instruct the gaming terminal to be changed to have the predetermine level when the game level determination means determines that the game level is changed to a predetermined level.

Here, the game media may comprise materialized media such as medals and coins and media having credit data which may be recorded in a magnetic card and an IC card.

Further, the cumulative game medium payout means may comprise means for paying out a part or the whole of the accumulated game values stored in the cumulative storage means.

In the gaming system (e.g., gaming system 100) of the embodiment as described above, it is characterized in that the gaming terminal (e.g., slot machines 101A, 101B, 101C, 101D, 101E) comprises: set game level display means (e.g., level display part 130) for displaying the game level specified by game level instruction information sent from the server (e.g., server 102).

Further, in the gaming system (e.g., gaming system 100) of the embodiment as described above, the gaming terminal (e.g., slot machines 101A, 101B, 101C, 101D, 101E) comprises: machine game level setting means (e.g., CPU 50, S5) for setting one game level among a plurality of game levels based on game level instruction information sent from the server (server 102); and game control means (e.g., CPU 50, S21-S33) for controlling the game based on the game level set by the machine game level setting means.

In the gaming system (e.g., gaming system 100) of the embodiment as described above, the gaming terminal (e.g., slot machines 101A, 101B, 101C, 101D, 101E) comprises: set game level display means (e.g., level display part 130) for displaying the game level set by the machine game level setting means (e.g., CPU 50, S5).

Further, there is provided a gaming terminal (e.g., slot machines 101A, 101B, 101C, 101D, 101E) utilized in the gaming system (e.g., gaming system 100) of the embodiment as described above.

Further, there is provided a server (e.g., server 102) utilized in the gaming system (e.g., gaming system 100) of the embodiment as described above.

In the gaming system of the embodiment as described above, a plurality of game levels are set to respective gaming terminals based on the lottery result by the server, the jackpot is won if the game level becomes a predetermined game level, and effect contents at gaming terminals are changed based on the currently set game level. Therefore, the player may have more anticipation to win the jackpot such that a variety of game can be provided.

In the gaming system of the embodiment as described above, the gaming terminal displays the game level having been instructed by the server and it is possible for the player playing the game with the gaming terminal and a new player going to play with the gaming terminal to recognize the game level having been set to the present gaming terminal. Therefore, these players can have high anticipation to win the jackpot.

In the gaming system of the embodiment as described above, the game level comprising a plurality of levels is set to the gaming terminal and effect contents of the gaming terminal varies based on the game level currently set thereon such that it is possible to provide a variety of game with the player's enhanced anticipation to win the game. And it is possible to retain the game state with high probability to wind the jackpot based on the game level between games such that the player playing the game with the same gaming terminal and a new player who is going to play the game with such a gaming terminal can have more incentive to play the game.

In the gaming system of the embodiment as described above, the gaming terminal makes the image display means display the set game level such that the player playing the game with the gaming terminal and a new player who is going to play the game with the gaming terminal can recognize the currently set game level. Therefore, it is possible for such players to have enhanced anticipation to win the jackpot.

In the gaming terminal of the embodiment as described above, effect contents of the game are changed depending on the game level being set currently, and it is possible for the player to play the base game with a variety of effect images relating to the jackpot. Further, it is possible to retain the game state with high game level corresponding to higher probability to win the jackpot between games, and the player who is playing the game with the same gaming terminal and a new player who is going to play the game with one of the gaming terminals can have enhanced desire to play the game.

In the server of the embodiment as described above, the game level is selected from a plurality of game levels for each of the gaming terminal, the jackpot is won if the game level becomes a predetermined level, it is possible provide a variety of game to enhance the player's anticipation to win the jackpot. Further, it is possible to retain the game state with high game level between games and the player who is playing the game with the same gaming terminal and a new player who is going to play the game with one of the gaming terminals can have enhanced desire to play the game.

What is claimed is:

1. A gaming system comprising:
a plurality of gaming terminals, each of which accepts game media, accepts a player's operation, conducts a predetermined notification, and pays out a predetermined value of the game media based on operation information of the player's operation and a game result caused by the operation information; and
a server being connected to the plurality of gaming terminals and including a memory for storing cumulatively a predetermined portion of total game media accepted by the plurality of gaming terminals,
wherein each of the gaming terminals controls the predetermined notification based on a game state in the each of the gaming terminals and game level instruction information sent from the server and pays out an accumulated value amount stored by the memory based on payout instruction information sent from the server; and
wherein the server sets one game level out of a plurality of game levels to each of the plurality of gaming terminals, conducts a lottery to determine whether to change the game level having been set to each of the plurality of gaming terminals so as to send game level instruction information to instruct each of the plurality of gaming terminals based on a lottery result, determines which gaming terminals have game levels changed to predetermined game levels, and instructs one of the plurality of gaming terminals to pay out the accumulated value amount stored by the memory when it is determined that the game level of the one of the plurality of gaming terminals is changed.

2. The gaming system according to claim 1, wherein the gaming terminal displays the game level as instructed by the game level instruction information sent from the server.

3. The gaming system according to claim 1, wherein each of the gaming terminals controls the game based on the set game level.

4. The gaming system according to claim 3, wherein the gaming terminal displays the set game level.

5. A gaming system comprising:
a plurality of gaming terminals, each of which accepts game media so as to perform a base game and pays out a predetermined amount of the game media based on a game result thereof;
a server being connected to the plurality of gaming terminals and including a memory for storing cumulatively a predetermined portion of total game media accepted by the plurality of gaming terminals; and
an external display device for showing a value of the cumulatively-stored predetermined portion,
wherein one of a plurality of gaming levels having different probabilities to win the cumulatively-stored predetermined portion, respectively, is set to each of the gaming terminals,
wherein a set game level is displayed only on one of the gaming terminals to which the game level is set,
wherein probability to win in the base game at the one of the gaming terminals is independent from the set game level,
wherein the set game level is renewed when the base game is resumed such that a same or more advantageous game level is set to the one of the gaming terminals based on a lottery conducted in the server until the cumulatively-stored predetermined portion is won.

6. The gaming terminal, which is utilized in the gaming system as recited in claim 1.

7. The gaming terminal, which is utilized in the gaming system as recited in claim 5.

8. The server, which is utilized in the gaming system as recited in claim 1.

9. The server, which is utilized in the gaming system as recited in claim 5.
